(19) United States
(12) Patent Application Publication
(10) Pub. No.: US 2007/0112574 A1
(43) Pub. Date: May 17, 2007

(54) System and method for use of mobile policy agents and local services, within a geographically distributed service grid, to provide greater security via local intelligence and life-cycle management for RFlD tagged items

(76) Inventor: William Sprott Greene, Fairview, TX (US)

Correspondence Address: William Sprott Greene, 1461 Meandro Ria, Fairview, TX, 75069, US

(21) Appl. No.: 10/913,887

(22) Filed: Aug. 5, 2004

Related U.S. Application Data
(60) Provisional application No. 60/492,684, filed on Aug. 5, 2003.

(51) Int. Cl. G06Q 99/00; G06Q 30/00; G06F 15/16

(52) U.S. Cl. 705/1; 235/385; 709/201

(57) ABSTRACT

This invention provides a system, method, and software program for providing software intelligence to Radio Frequency Identity (RFID) tags. Utilizing the unique characteristics of the Service Grid, mobile software agents can relocate in close proximity to RFID tagged items. Once associated with the tag, these RFID agents migrate near where items are identified to provide local control, environmentally responsive policy, and ongoing permanent data capture & history. These RFID agents respond to events as circumstances require. They transport data and policy between supply-chain partners when the partners participate in a secure extranet. Enhanced service grids composed of distributed agents, comprising numerous services, facilitates supply-chain security and integration as virtual software service agents, including virtual RFID tags, are directed from one computer to another computer in response to changing conditions.

### CROSS-REFERENCE TO RELATED APPLICATIONS

The present application is related to and claims priority from co-pending U.S. Provisional Application 60/492,684 filled on Aug. 5, 2003, and entitled “Use of an Assurance Ecosystem to provide local intelligence & life-cycle management for RFID tagged items”. The above-identified application is incorporated in its entirety herein by reference.

### STATEMENT REGARDING FEDERALLY SPONSORED RESEARCH OR DEVELOPMENT

N/A. No federal funding.

### REFERENCE TO SEQUENCE LISTING, A TABLE, OR A COMPUTER PROGRAM LISTING COMPACT DISK APPENDIX

N/A. None provided.

### BACKGROUND OF THE INVENTION

1. Field of the Invention

The present invention relates to network and information technology.

More particularly, the present invention relates to providing enhanced security and management to supply chains. Still further the present invention relates to providing continued data collection for any item tagged with both active and passive Radio Frequency Identification tags (RFID), to providing for policy control of business processes on identification of an RFID tagged item, and for enhanced motion and position tracking of RFID tagged items throughout their active life.

The invention also relates to providing a survivable service grid IT infrastructure for business services and automation.

2. Reference Terminology to the Invention

As shorthand, the system of this invention is referenced by the proposed product name instead of the entirety of the extended title of the invention. The title of this system product is Ellipsis (linking the three dots as a reference to dot-sized RFID circuitry). Ellipsis includes the mobile agents, infrastructure services and business services which provide the specific functionality described herein.

Ellipsis provides software intelligence to Radio Frequency Identity (RFID) tags. Utilizing the unique characteristics of the Service Grid, mobile software agents can relocate in close proximity to RFID tagged items. Once associated with the tag, these agents locate nearby and provide local control, environmentally responsive policy, and permanent data capture & history. Ellipsis is agnostic as to standards, tags and reader vendors supporting each through specific services.

3. Description of Related Art

This section starts with a comparison of the Ellipsis approach to that of the MIT Auto-Id Center which has been adopted in part by the follow on EPCglobal organization. It also analysis other proposed approaches and compares these to the Ellipsis solution.

RFID systems today come in two flavors. Traditional RFID use proprietary tags and readers to identify stock, determine location from the reader placement and pass the (identity, location, time) data to Commercial Off the Shelf (COTS) business package software (often SAP or Manhattan Associates). All systems in use today are like this.

### Auto-Id and EPCglobal Proposed Standards

The second flavor comes from attempts to standardize the front end of the data capture and identification process. This standardization of the field is being supplied by the Auto-ID center, a collaboration of academics (MIT) and industry (retailers and technology suppliers.) The Auto-ID center has taken the approach of using RFID to enable an “internet of things”. They are adapting Internet middleware technology to provide this functionality. That code being developed, is a combination of Java scripts, adapted DNS and XML database code.
EPC—96 bit number with product class, vendor, and unique serial number
Readers (standardization) must discriminate tag read backs and coordinate turning on and off tags)
Savant acts as a ‘data router’ capturing, filtering and forwarding the data
ONS (Object Name Server) that is adapted DNS server code. Takes EPC and finds home database for object assuming databases will be Internet reachable.
PML servers—store XML encoded info on product in PML markup language.

With Auto-ID, every RFID tag becomes a client. A reader system picks up product type, manufacturer, and serial number (EPC) and Savant connectors package this data as Events adding reader Id and location and the time the item was read. The Event is then routed through a series of filters and forwarding queues. During this process is it temporarily stored in an in-memory database and optionally passed to various logging and persistent data stores. Various Java scripts, launched by a Unix Cron derived task manager, can act on the Event. One such task will typically be looking up extended information about the tagged item via remote calls to the ONS and PML system. This request goes to an Object Naming Server (ONS), which is a modified DNS server. [DNS servers translate URLs to IP address so routers can route clients to specific servers connected to the Internet.] The query task takes the routing information from the ONS and places queries with either local or remote (manufacturer) PML databases, thereby establishing a local cache of basic unchanging data about the object. Another task allows data to be passed from the in-memory data and cache to external application systems generally via response to an external query. The information is stored in an external application database and reports are run to provide analysis and business functions.

The AutoId center is not concerned with updating information about objects as they pass through the supply chain. It is not concerned with automation of business processes where items are read. This system simply packages tag reads as events, associates these with basic manufacturer data, and makes this information available to external business applications.

See FIG. 1: Prior Art for RFID Middleware

While the reader to event identification software from the Auto-ID organization is patterned on existing Internet-middleware services, open source databases, and Unix-like utilities, effectively, this approach just dumps event data into near-obsolete client server architecture of the 90's. To be used the reader data must first be filtered (whereby most data is discarded) and then end up transported into massive database systems that can deal with the millions and eventually trillions of data triplets (identity, place, time) coming from throughout the supply chain. All the business logic is remote from the physical device that was tagged.

### Other Approaches

One Auto-id participating vendor provides a traditional data-reporting environment for stock identification and control. RIFD for them is just another way of identifying goods. (Similar to barcodes applications)
Various reports can be produced.
Specific analysis of incoming data may generate reports (unclear promise)
Filters are used to reduce data.

All the data is hauled back from collector systems to intermediate processing nodes and eventually passed to external business systems (such as that of the vendor SAP). They call their approach a “leaf node” architecture, but is really just a hierarchical linkage of computers passing data.

Yet another middleware software vendor, engaged in the Auto-id Center design, strongly interacts with the tagged item readers. Their basic architecture is to put proprietary software (embedded agent or java application) on a computer connects to a reader device so that the device can have secure communications, using a protocol, back to centric enterprise services. These enterprise application services therefore receive a greater amount of info from the reader device and can embed the tagged item, by proxy, into business process and work flows. For them a reader device is a field deployed POS terminal, handheld inventory scanner, kiosk, RIFD reader, or another device that, while it contains a computer, is not a general-purpose computer. Nevertheless, it has to have a processor, storage, and memory to contain their embedded agent. Limited remote configuration of the application is possible through sending XML meta-data to the application adjacent to the reader.

Competitor architectures which provide for remote device communication with large, central servers providing intelligence, contrasts with Ellipsis architecture's mobile intelligence, represented as Microservices, that join to form diversely distributed applications.

While the traditional & competitive technical approach is solid, it is not as advanced, flexible, reliable, and securable as future RFID applications demand. For instance:
Their approach to security is to develop a comprehensive new “protocol”. In general this is the mainstream approach. It is a place where the Service Grid and Ellipsis are strongly differentiated. We believe in using services, specifically mobile services, instead of protocols. This allows for general and specific solutions that are easily changeable and can scale better.
They do not have a concept of moving the intelligence from the central enterprise out close to the device. For them brains are in the center which has good communications with the edge. We move intelligence close to devices.
In the reader agent connected to central processor approach, deployment is simply hub and spoke; a model which does not scale to global deployments. For Ellipsis, deployment is globally dispersed services in an N×N redundant computing grid, with an inbuilt concept of regional domains.

Other systems, in order to overcome limitations in the Auto-ID architecture, act to intimately manage and control devices; Ellipsis enables and virtualize devices, modeling them as services in a distributed control system. While they are restraining edge devices, Ellipsis is allowing edge devices to evolve and adapt to changing conditions, by adapting our software to edge device enhancements and innovations. I believe, that currently, we are seeing only the earliest generation of RFID readers. I expect that the functionality and intelligence of these devices will progress rapidly as reader vendors attempt to improve and different themselves. This approach is to adapt proxy connectors to the new features of these readers as the devices improve, providing immediate software facilitation of reader improvements.

Because I expect readers to rapidly improve, instead of putting an agent on readers to overcome current limitations in these readers, Ellipsis provides a intelligent proxy. Therefore it can support very intelligent readers with all their facilities, but also, we can support dumb, or limited intelligence, devices. Market forces also will drive readers into very small, low cost implementations that do little more than send tag values back via a network connection; this so that many readers can be dispersed thought an environment providing area coverage. So Ellipsis is not limited to supporting devices that are computing devices.

I expect that the future will be a heterogeneous mix of readers with many different functional characteristics. Very intelligent, high volume readers will be placed at physical gateways (entrances, exits, path junctions) so that the large number of objects passing these points can be quickly identified. But the rest of the warehouse area will be provided coverage with small, inexpensive sensors and readers that just report back that things are pretty much staying the same. The Ellipsis' intelligent proxy connectors support this heterogeneous mix.

### Auto-Id in Practice

Traditional approaches send the data back to central systems where reports are run. Very seldom is local intelligence used beyond printing of stocking reports or exception alerts to people. The Auto-Id center concentrates on development of front-end software called Savant.

See FIG. 2: Prior Art for RFID Middleware

Savant has many technical software issues to overcome:

Data smoothing from radio reads
Reader coordination including interference and multiple reads of the same tag
Data forwarding (and implied filtering)
Data storage at high transaction rates and volumes
Event and task management

For instance a database can handle about 100 transactions a second per processor. An Auto-Id reader can read about 50 tags a second. So basically one database processor could only support 2 readers, adding between 5-20× the expected cost of a reader to the system. In reality Savant provides a string of filters to eliminate most of the tag reads from downstream processing. So some data is deliberately lost, and other data is accidentally lost I these queues and filters—eventually many reads are turned into a strong guess that a significant Event has occurred (such as a departure of a tagged item from the scope of the reader). These events are then placed into an in-memory databases to handle the high rate of transaction feeds and to be a short term historical queue from which other applications can draw out events. Sacrifice of ACID and transaction properties is a side effect.

To deal with the high volume of expected data flowing through the network, the Savant architecture envisions a string of systems that receive information, store it at interim locations, and forward only some data. But this approach has a side effect of greatly augmenting the fragmentation of information (which is quite different from the dispersal of information.)

Another part of the Auto-Id system is the lookup of external, static information on items that are locally read. The ONS server is a big lookup and redirection engine for finding where data is or where data should be sent. ONS is adapted DNS technology.

Jini performance is functionally superior to DNS for interface type lookup when modified for applicability in long, haul unicast networks. This allows items to be represented by services and not just static data fetched via a distant query.

But just having data is not sufficient for enterprise applications doing business jobs that require precise, relevant information. Local reports must be run, jobs scheduled, and workers notified of special events. This is a fragmented process in the fragmented data environment of Savant RFID software. Basically, management only gets a high level ‘health’ console derived from forwarded subsets of data; workers get only the info in their specialized Savant node. At best, ONS is used to find static PML databases and then special applications must fetch and merge the data for a report or process.

There is a significant problem with the ONS lookup server architecture. ONS servers will be locally owned and maintained by companies further augmenting the coordination problem between companies cooperating or indirectly participating in a supply chain. Many Supply chain corporations mean many ONS servers are needed. Unlike DNS, these will not always be replicated images of the whole area, but specialized for the needs of the local Savant management applications. How does this morass get updated and synchronized. How is the data checked for integrity and timeliness? In the Internet, it can take as much as 3 days for updates to filter through the DNS system.

This becomes an issue of public health significance if the recall of an item by one location cannot get prorogated to the location that has the item in proximity. Similarly, and item found to be of suspicious or hostile nature, perhaps introduced to a supply chain by terrorists, may not be findable in the morass of global savant systems during the critical period of timely response.

This fragmented, dispersed, repetitive and overlapping data environment is not just a by-product, it is the current-practice solution to a very real problem of the massive data throughput and accumulated data volume generated by RFID tagged value chains. It is our contention that this architecture exacerbates future problems of data integration. Real problems exist in maintaining synchronicity and accuracy in the many copies of information. These interim PML data stores cannot easily support transactions and may be effectively limited to read-only reporting. Controlling the flow of information into these specialized PML systems, so that correct, synchronized data is systematic, becomes a major ‘higher-level’ application and not the ad-hoc process envisioned in the architecture. Mostly real-world change data will never get back into PML databases, residing in back-office reporting systems and data warehouses that are proprietary to their owner corporations.

Gathering information from all these sources a major task of many parallel queries, many comparisons, resolution of discrepancies (a major task), and the final ‘mung’-ing and integration. This is a task that is familiar to reformers of the Telecom stovepipe architectures of the last century. It is not solved except by extreme heavy lifting, usually into very-large data warehouses. One expects to see a reemergence of publication-subscription message systems and fresh territory for EAI sales.

The problem is only compounded when the entire supply-chain, and the value-chain is considered. This value-chain is made of many different discrete global organizations: sometimes these are specific business centers, other times these are separate companies. There is no simple way of coordinating this information. Eventually the data is recorded in individual, restricted access mainstream systems. Data re-integration is nearly impossible in this form of environment.

Perhaps the Auto-id Center architecture will evolve to have specialized PLM servers (on a VPN or outside the respective company firewalls) available for external lookup and which receive filtered data updates. But special “standards-derived” applications will be needed to enforce this. These take a long time to be accepted.

In fact, today the B2B movement is adopting web services as a means of communication among separate corporate entities. Auto-Id standards address this via a SOAP connector to Savant. Web services can communicate information but it does not solve coordination of information. Some data gets passed along via the SOAP protocols and the web service work flows, but other data is not forwarded and becomes ‘misplaced’—often lost from the B2B system exchange. Managed web Service applications address this, and many RFID vendors are moving to provide this.

So a big question for traditional architectures becomes “where is the information” and how to coordinate process and data to provide “unified views.” These are the kind of problems that service ecosystems excel at overcoming. Both of these problems are addressed and solved in the exemplary realization of the Ellipsis software.

### Ellipsis Value Add

This invention will replace earlier approaches with more advanced technology that is standards compliant, but provides a more highly functional, commercial model. It is my belief that the browser, internet-middleware, data-server architecture which works well for people reading data out of browsers that was fetched from remote servers does not effectively match to dumb tags sending location, time information back to a central processor. Like the human on the end of the browser, local intelligence is needed to assess what to do—right then and there.

Herein lies a central limitation of RFID that this invention leverages. The economics of (mainstream) RFID require a very low cost, mass manufactured tag. Engineering represents this as low or passive power and memory limitation to just the EID number. The RFID tag is the ultimate in stupidity: it cannot afford to know more than what it is, who made it, and its own name. It is fundamentally not aware and is not able to do anything with this identity information. External technology must read this information, understand it and direct the actions of the environment in manipulating the tagged item.

Traditional approaches send the data back to central systems where reports are run. Very seldom is local intelligence used beyond printing of stocking reports or exception alerts to people. Ellipsis provides local policy and collaborative work tasks that deploy into the forward environment where automation takes place.

A very real problem of RFID systems remains the potentially massive data throughput and accumulated data volume generated by RFID tagged value chains. Current practice before Ellipsis is to fragment unchanging data into lots of isolated PML data servers linked by protocol requests and to fragment session data (location, time, state) into closed, external applications owned and controlled by local members of the supply chain. Gathering information from all these sources becomes a major task of many parallel queries, many comparisons, resolution of discrepancies (a major task), and the final ‘mung’-ing and integration.

The Data Grids of global service architectures (data-grids) were designed to solve these very problems. Ellipsis will employ these to maintain a higher-level distributed coordination of data, while maintaining a standards compliant, virtual distribution of specialized PML servers. Where the PML services already exist outside of Ellipsis control, Ellipsis services will attach to existing PML servers via a proxy adaptation interface. Where these are internal, external programs will ‘see’ a virtualized representation of a PML which is not real, but instead a local view from the fully distributed global data grid.

Another limitation of the Auto-Id approach that this invention can leverage is the software structure of the Auto-ID standard architecture. While this architecture is optimized to handle enormous rates of tag reading it is not equipped to handle enormous amounts of data or to do anything intelligent with the data. Further the architecture relies on significant system management expertise to layout the configurations of all its ‘Lego-like’ building block services. Ultimately, the system is cumbersome and fragile. Ellipsis replaces these java scripts with the Service Grid, thereby gaining all the advanced platform value of this global distributed service architecture—most notably survivability, integrated software deployment, ease of management, adaptive policy, smart legacy application gateways, and extensive data integration.

But the real world is one of cohabitation not greenfield replacement. Because of this, Ellipsis will both bind to Savant/Auto-ID reference applications and also supersede and replace these functions. This dual approach provides realistic flexibility and needed commercial robustness. For instance, some readers will likely come bundled with Savant edge code. For this case, Ellipsis implements the Savant APIs utilizing these connections. In other cases, Ellipsis must find and fetch basic product data from remote vendor systems that have implemented a PML database and identified it on a global ONS server. But generally, Ellipsis duplicates Savant functions by mimicking Microservice clients that attach to the core Javaspace. This javaspace provides a stronger facility for routing events and managing tasks.

Lastly, Ellipsis is agnostic, supporting multiple standards and approaches. It is not dependent on customers and tags adopting the Auto-Id recommendations. For instance, Ellipsis supports the GTIN (Global Identification Code with GBI/B&B DUNS number) numbering scheme as well as others like SSCC (Serialized Shipping Container Code), IATA numbers, ANSI Data Identifiers and motor industry VINS etc. It implements RossetaNet data definitions & B2B flows, TeleManagement eTOM workflows, CommerceNet suggestions. Ellipsis provides translation agents that facilitate aliasing products and data from many sources. It will provide connector services to any tag/reader system that provides an interface, even to supporting ‘screen scraping’ of user command sessions. Via policy services and collaborative work models it implements many dialogs for B2B and supply chain interaction. With is ability to establish smart gateways to external applications (legacy, heritage, and just market established), it can control the flow of information to and from internal and external business platforms. Ultimately, Ellipsis allows all these disparate systems to be unified in integrated policy and common process, producing directed business value from diverse source materials.

### Supply-Chain Conclusions

Shortfalls of the Current Savant Architectural Definition:

Large reliance on filtering data out to handle scale. Since the result is ‘digestible chunks of information’ for heritage supply chain applications, data is winnowed down and transformed.

Potentially important information is thrown away, never to be recovered.

This assumes one can accurately predict, at the point of installation, all the stuff you will ever need to know in the future.

Because filtering decisions determine how many servers to deploy, how to deploy them, and how they will report up to each other in the Savant hub-and-spoke scaling model, a simple decision to make more data available to an ERP/procurement/warehousing program can require redesigning the entire Savant architecture.

Savant is directly dependent on OS for application platform. Modern systems use application server technology like J2EE or distributed service systems like Jini and .NET. Enormous gains in programmer productivity result. Savant is not a service or component system, but instead an amalgam of compiled and script programs strung together by an adaptation of UNIX scheduling programs. No use of naming and registry services or advanced service discovery.

No built-in management model. No ability to monitor or query components on their health.

Savant uses a push model for process realization that is complex, hard to design, balance and implement. Message flows can break. Modern systems use pull methods or async/parallel communications. Much simpler to design and more reliable.

No security model built into the architecture of Savant.

Security actions can be added, but they are band-aids on system components well-known to hackers.

Authorization and authentication must be “wrapped-around” fundamentally insecure models of data-sharing in order to communicate with supply-chain partners

Ellipsis Advanced Security Features that Support Rigorous Homeland Security Directives in the Supply-Chain:

Non-repudiation of transactions at the message and service layers, so that event delivery and processes are secure from failure.

Encryption of data regarding product information and users

Encryption and safeguarding of processes so that these stay secret as needed (requires object representations of these).

Authentication of all external touch points: users, databases, ISV software, etc., both actively (AAA) and passively (e.g., intrusion detection systems, sanity checking). Ideally, this is linked to easy-to-manage policy-based permissions and Access-Control-Lists (ACLs).

Accounting and secure logging of all system changes and significant events.

Ability to correlate this with specific system and user actions.

High-availability/Backup systems to recover from hardware or other failures. More ideal, of course, are Survivable Systems, which are proof against all accidental and deliberate attacks, from component failures, to power outages, to explosions in data centers.

Integration of reader device management and data collections coupled with fraud detection systems, so that breaking or tampering with a reader does not allow theft or product tampering.

Architectural Components Emerging as Necessary for Advanced Middleware Systems:

Communications layer: early generation systems use API messaging (IIOP, RPC), mid generation systems use publish & subscribe, late generation systems use RMI, net remoting, and space-based computing.

Naming, registry and discovery services allow services to interact and be managed individually and as a whole. Jini lookup and UDDI are replacing LDAP directories that, in turn, replaced object brokers (ORBS).

Grid-like server platforms are replacing multi-processor server clusters

Process control via workflow is being superceded by policy directed behaviorist systems.

Distributed transactions and distributed data storage across multiple databases, SANS or like are replacing monolithic transactions layers.

Device-independent user access via wireless and location services is replacing consoles and message pagers.

Built-in management systems with management APIs in all service components. Ultimately this allows for self-healing systems.

### Auto-Id and Control Systems

A fundamental departure from existing practices is the introduction of a notion of ‘intercommunicating services’ rather than ‘protocols between servers.’ This idea has been most effectively expressed by the Jini development community and was fundamental in the architecture and design of the Jini Network Architecture. Basically, a service can find and download the remote interface of another service. This interface can provide the methods and the protocols for communication between the services.

Basically standardizing protocols, getting them correct and getting them agreed to is a long and costly process. It always falls behind technical ability. With the service approach, this standardization of protocol is unnecessary. All you need is agreement on the structure of information and methods between the two services. Every service in the common grid can adapt and evolve as fast as communication methods are invented—incorporating these advances within updated communication proxies which are propagated via code loads as the services are deployed.

### Service Grid Invention Background

The Service Grid described herein is an advancement on several prior versions of service grids and service ecosystems. It combines several historical technologies utilizing some main features of them yet discarding those features which caused problems and inefficiencies.

The Service Grid is a collection of canned services and a tool-kit for developing additional specialized services via inheritance. The tool-kit, a software component development framework, allows companies to write, deploy and manage their most crucial applications as coordinated federations of mobile Microservices. In this framework, the system senses software failures and replaces ailing pieces with healthy ones. Companies using the Service Grid are able to enjoy levels of reliability and performance previously possible only with extremely expensive hardware.

The Service Grid is a component framework for building distributed applications. Distributed applications built with other component frameworks, such as EJB or COM+, are composed of static components fixed to the computers onto which they are installed. If the server or network an application resides upon fails, the application likewise fails. Clustering technology presents a limited solution to this problem by enabling a handful of servers to share the load so that other servers in the cluster can pick up the work of a failed server. However, clustering's drawbacks are severe. The cost of clustering is inflated by the specialized hardware and software required and the extra servers/capacity that will only be used in the case of failure. Furthermore, it is usually impossible to deploy members of a cluster in anything but the same LAN. So while a clustered application may be impervious to a single server failure, it is still at risk of network, power, or other failures that affect the whole room.

Distributed applications built to run on the grid are composed of distributed agents, called Microservices, that can move from computer to computer in response to changing conditions. If an individual component of an application fails for any reason, the system senses the failure and simply re-launches a healthy replacement. State information is persistent, so the replacement can start right where its predecessor left off. And unlike applications in traditional tightly coupled architectures, Service Grid applications are protected from the cascading failures caused when a single component fails.

These Microservices are written in standard Java for platform independence. They are bound into complete applications using Space-Based Computing (SBC) for loosely-coupled communication and integration, Jini for dynamic discovery and interaction between agents, and proprietary technology for deployment, database access, and ancillary services. Combining these approaches yields benefits unforeseen by users of SBC, Jini, or distributed agents alone.

Distributed agent applications built with Service Grid have advantages in security, stability, efficiency, and scalability.
Stability (survivability): applications running on the Service Grid will not go down until nearly all computers running Service Grid go down. By running Service Grid on a suitably large number of (optionally pre-existing, optionally inexpensive, optionally undedicated) systems, spread out on different network segments, extraordinarily high (greater than 99.999%) uptime can be obtained.
Efficiency: with traditional methods, servers must be sized to handle peak loads, even if average loads are much lower. Often, some group of servers can become overloaded while others are underutilized. In contrast, when participating in Service Grid, servers can be used up to peak capacity all the time, running agents from potentially several different applications, without running the risk of overload. Load is shared in Service Grid between all participating hosts, eliminating tedious and costly ‘tuning.’
Security: no single point of attack for intrusion or denial-of-service.
Scalability: distributed applications written on Service Grid do not require special clustering or load-balancing systems to scale past any upper limit. Applications can be scaled in a near-linear capacity for several orders of magnitude.

The Service Grid dramatically lowers the costs of developing and deploying mission-critical applications, shifting the emphasis away from expensive and redundant machines towards lower-end utility hardware. This not only decreases the costs of protecting critical applications but also lowers the threshold for what can be considered “mission-critical.”

### Background Technology

This specific invention enhances on standard service grids. Current art has these as static deployments of web-services on application servers. This heritage business grid deployment, and the Globus Business Service Grid designs, can be implemented as functional subsets of this newly described Service Grid.

This significantly enhanced Service Grid architecture combines aspects of several longstanding fields of research in computer science to reach a surprising set of results: a whole that is much greater than the sum of its parts. Briefly, these include:
Grid Computing
Component Framework Architectures
Service Oriented Architectures (SOA)
Space-Based Computing (Jini & JavaSpaces)
Mobile Agent Technology
Peer-to-Peer (P2P)/Groupware
Distributed databases
Policy, Rules & Process Management
Secure VPNs & Policy-based Networking
Some of these foundation technologies are implemented in intellectual property, products and patents granted and now owned by:
MCI's Global Ecosystem (pending patents by self-same Inventor)
IBM's Aglets
Sun Microsystems's Jini & Javaspace
Sun Microsystems's Rio
Cisco SI
Grid computer companies
Auto-id and EPCglobal standards
TeleManagement Forum NGOSS standards work
   While this patent derives from a broad base of prior art, yet it provides for a novel integration and adaptation of many ideas in unique ways such that whole is much greater than foundation technologies.

### Contributive Knowledge Domains

Grid Computing: A Grid is a type of parallel and distributed multi-computer system that enables the sharing, selection, and aggregation of resources distributed across multiple discrete computers based on their capability and resources availability. Examples and Vendors: Sun N1, IBM A, HP Eliza, Microsoft Dynamic Systems Initiative, Datasynapse

Component Framework Architectures: Component software systems are composed of pieces of software that are isolated into discrete, easily reusable structures. Generally a component is a large block of code that performs a predetermined subset of all the functions needed in the overall system. Architecture is the blueprint for the various components, what they do, and how they interact. See: OMG CORBA II (Common Object Request Broker Architecture), TMF NGOSS (New Generation Operating Systems and Software)

Service Oriented Architecture (SOA): An SOA is an architecture made up of components and interconnections that stress interoperability and location transparency. Examples and Vendors: Web Services, .NET, Java JXTA, Jini systems

Space-Based Computing (Jini & JavaSpaces): Space-based computing is a programming method invented in the Yale Linda project that coordinates the sharing of objects among a distributed system of discrete computing sources. (Also called tuplespaces). JavaSpaces is an interface standard for central control of objects blindly passed between client services. Jini is a specialized tuplespaces architecture for remote interaction among services. Examples and Vendors: JavaSpace: IntaMission Autevo, GigaSpaces, Sun Outrigger; Jini: Sun Rio, Valaran; Worldcom's NewWave Global Ecosystem.

Mobile Agent Technology: Mobile agents refer to self-contained and identifiable computer programs that can move within the network into machines that provide agent hosting capability and act, either independently or in concert with other agents, on behalf of the user or another entity. Examples and Vendors: IBM Aglets, Tryllian, www.projectory.de/kaariboga, General Magic, Inc.

Peer-to-Peer (P2P)/Groupware: P2P has become and overloaded term that alone conveys no meaning—P2P can contain notions of peers as agents, collaborative work, distributed objects, file sharing and messaging. (The popular and politically charged use of P2P defined ‘as a file sharing application shifting the locus of control from the center to the edge’ is not how MA uses P2P). P2P is the peer, agent-to-agent, interaction of two or more services via messages and files and includes: a grouping notion, the ability to monitor and meter, and a security layer that can enforce isolation. Notions of grouping and collaboration of peers provide for direct sharing and indirect sharing of objects via JavaSpace. Examples and Vendors: Groove Networks; Datasynapse; JXTA; Ecocys Technologies; Risk2Risk; Consilient

Distributed databases: A union of two or more databases on multiple distinct servers into a consistent data layer that is represented to requestor clients as one interface. Generally the identity of the multiple internal databases is hidden from outside clients. Often the interface is provided by a gateway that fronts the databases. In E, this is realized thru a distributed object layer that brokers interactions with potentially thousands of databases that support the XA standard. See: XA-extended Transactions standard. Examples and Vendors: Supported by Oracle, Versant, Tuxedo.

Policy, Rules & Process Management: Policy has become a much-overused term. I use Policy as (1) externalizing procedure and business logic as rules and (2) Policy-based Management for the dynamic adaptation of networks. Generally Policy is used to enable behaviorist computing where agents are event driven, that is, a policy agent subscribes to a class of events, when it receives the event it tests this against conditions and then when the condition is met, takes an action. (ECA: Event, Condition, Action). See: IETF Policy, Rules Engines, PCIM, TMF NGOSS. Examples and Vendors: Intelliden, Dorado Software. Enablers: Cisco, Juniper and other PBM routers, Blaze Software.

### Best Current Practice in Component Architecture

The Service Grid builds upon and extends past work in component framework architectures (CFA). This prior work includes:

OMG Component Architectures: OMG component architectures are standardized by the Object Management Group and resulted in the CORBA II specification. CORBA II provides a tight, compile time model of service binding which experience shows results in application rigidity and development delays. The specific CORBA II technology is decreasing in market acceptance as newer systems occur. However, OMG is taking on new roles in technology neutral specification of inter-operative component systems.

EJB Architectures: By far the most dominate expression of a CFA in today's market. EJB provides for a an application server (instead of a container) which coordinates interaction of services. There are utility framework services provided through standardized interfaces. It uses a tight design model of service binding, but a runtime binding of the utilities. Rigid interface design means new framework services are developed though a complex and time consuming standardization process.

Microsoft COM+, DCOM & .NET: The newest entrant into CFA, Microsoft provides a loosely organized set of utility services which enable remote communication between services. These facilities, coupled with characteristics of the C#language, can be used to develop an ecosystem just as Java language does. Mission Assurance is developing Assurance.NET which will provide essentially the same features and the Java version.

NGOSS Component Architecture: Widely recognized as the strongest integration of Business Process Modeling and Component Framework Architecture. New Generations Operating Systems Software (NGOSS) provides a strong documentation of binding definitions via a Contract artifact. NGOSS provides an emphasis on delivery of business logic as Process and Policy as segmented from Framework Utility services. It also advocates utilization of a common information model as an aid to integration of components built and delivered by different suppliers. Both technology neutral requirements and specifications and technology specific working examples are provided in the standardization processes.

### Best Current Practice in Service Grid Architecture

Grid service architectures are the future of computing. These systems call for a physically distributed group of computers interconnected by a network. Services run in these computers and use the network to communicate with services on other computers. It is basic in a service grid that services are not autonomous—either by design or deployment; services rely on interacting with other services to get the jobs done.

The Service Grid builds upon and extends past and present work in service grid architectures (CFA). This prior work includes:

MCI Worldcom's NewWave: The original Application Ecosystem, NewWave was developed at MCI Worldcom during 1998-2001. This inventor is one of the existing patent holders on NewWave technology. This Service Grid departs significantly from the prior art.

Global Grid Forum (GGF) Grid Services: Originator of the Service Grid term for this type of distributed computing the GGF brought together server academic groups and business industry leaders to define a common standard. This architecture is not technology neutral. Basic architecture calls for Application Servers fixed to a Computing Grid to discover each other and invoke distance services via web service exchanges. It also provides for Job scheduling and distribution of tasks on the Application Server Grid. The standardization of framework services and communications interfaces is significant. The Service Grid implements many of these to facilitate interoperability with other business service grids.

Distributed Object Systems: Several historical systems have provides systems where objects discover each other and exchange information. These rely on inheritance to provide common interfaces among the objects that then use framework services to coordinate communication. It is possible to extend these systems via a grid of computers.

### Improvements to Prior IT Technology

Each of these fields has proceeded on its own for years with varying degrees of success. Grid Computing, for example, is a viable and cost-effective method for handling large computational tasks. Jini's technical advantage have been overshadowed by the fact that mobile devices have failed to progress rapidly enough, and mobile agents do not work collaboratively and therefore have limited utility. The Service Grid was influenced by each of these computing technologies; relevant principles were used when they supported the goals of delivering mission assurance in a global system.

In order to clearly explain and contextualize this technological innovation, it is necessary to define some basic terms. Service Grid is a Service Oriented Architecture (SOA) for component applications. Services are programs with a dedicated function that have a simple and standard way of communicating with other services. Component applications are applications built from elemental pieces (components) that work in concert to perform more complex tasks. ‘Microservice’ is the new term invented in this specification and applied to components in its architecture. At a high level, our Service Oriented Architecture is designed to handle the following problems that arise when deploying a large number of Microservices:
How will Microservices recognize and find each other?
How will they communicate in an effective and scalable manner?
How will they allocate work and prioritize tasks?
How will they sense failure and regenerate themselves?

This invention uses a distributed component software framework, like EJB or COM+, which defines how Microservices should be built and how they will interact. The Service Grid provides:
A middleware platform for communication and coordination between Microservices
A management platform for self-regulation and a single point of global control over deployment, performance, and security
Specialized JVM (Java Virtual Machine) or .NET remoting containers for running the Microservices dynamically
A library of pre-built Microservices to speed application development

Java developers writing applications for Service Grid use the same development methods and tools they have always used. The difference is that instead of writing their Java applications as EJB components to run inside J2EE application servers, they write their Java applications as Microservices that run on the grid. Applications are uploaded to the management platform, which regulates the way in which the individual Microservices making up the application are deployed to all the servers running containers.

Because the containers are lightweight JVMs, not large application servers, they can be installed on pre-existing machines that already have a “day-job.” The failure-proof features of Service Grid work not only when servers fail, but also when server priorities change. The Service Grid management system will dynamically redeploy those Microservices to other available resources.

In this way, Service Grid unlocks the unused and underused resources hiding in existing IT systems and puts them to use where they are needed most. These resources can be used to run new applications or to “pick up the slack” when other resources die. With Service Grid containers deployed on a number of servers, even undedicated ones, spread out in different locations and network segments, applications can be made invulnerable to failure.

This invention is a service grid built on distributed agents. It uses characteristics of distributed object systems in the production of these agents. Rather than relying on heavy weight Applications Servers to host objects, The Service Grid relies on lightweight, remote deployable containers to host agent services. Rather that rely on web services for inter-service communication, this invention follows the more flexible Jini Network Technology model where services provide their communication process and protocol in shared proxy code which is distributed from the resource service to the consumer service. Web-services are implemented as one of many feature sets of this technological approach.

### SUMMARY OF THE INVENTION

The present invention is directed to a system, method, and software implemented system of services for providing supply chain security and management of RFID tagged items. The present invention utilizes networks to enable a distributed Service Grid. More particularly, the present invention provides enhanced security and management to supply chains. Still further the present invention provides continued data collection for any item tagged with both active and passive Radio Frequency Identification tags (RFID), to providing for policy control of business processes on identification of an RFID tagged item, and for enhanced motion and position tracking of RFID tagged items throughout their active life.

As shorthand, the system of this invention is referenced by the proposed product name instead of the entirety of the extended title of the invention. The title of this system product is Ellipsis (linking the three dots as a reference to dot-sized RFID circuitry). Ellipsis includes the mobile agents, infrastructure services and business services which provide the specific functionality described herein.

Ellipsis provides software intelligence to Radio Frequency Identity (RFID) tags. Utilizing the unique characteristics of the Service Grid, mobile software agents can relocate in close proximity to RFID tagged items. Once associated with the tag, these agents locate nearby and provide local control, environmentally responsive policy, and permanent data capture & history. Ellipsis is agnostic as to standards, tags and reader vendors supporting each through specific services.

Ellipsis software automates the collection of data from RFID readers, allowing immediate & responsive local automation to be triggered by reader and sensor events, and providing digestible data to heritage warehouse and ERP applications. With Ellipsis, mobile software agents relocate in close proximity to RFID-tagged items. Once associated with the tag, these agents follow goods and provide local control, environmentally responsive policy, and permanent data capture & history.

### RFID Agent

The basic idea behind the RFID agent is simple. Because of economics, RFID tags must be small, simple, and conservative of power. This limits the data that can be contained on the tag and the ability to write fresh information to the tag. Mission Assurance's RFID agent is a virtual business object that is linked to the RFID tag via the specific identity code that is written to the tag. All the information that world be useful to have at hand, but cannot be stored on the tag, is written into the RFID agent.

Besides the manufacturing data (typically makeup, composition, lot numbers, delivery instructions) that is stored in the RFID agent, the agent can also store policy in the form of rules (event, condition, action statements). The agent subscribes to events and reacts according to the instructions in the rules whenever it receives a triggering event.

See FIG. 3: RFID Agent Follows Tagged Item Through Supply-Chain

The RFID agent moves about in the supply chain following the tagged item. Whenever a read of the tagged item occurs, the RFID agent discovers this and locates into the closest free resource container in the system. As the tagged item moves about in the supply chain, new data is added to the RFID agent so that it contains a complete history of the item.

### Service Grid

This Service Grid is an enterprise software platform composed of hundreds of small, reusable services that self assemble into business applications. These “Microservices” deploy remotely and automatically discover and use all resources needed to perform more complex functions, often communicating via Space-based computing. Thus an Ellipsis application is built from an adaptive, interacting community of local and enterprise based Microservices.

The Service Grid enables complex systems for which failure is not an option. Because it is never possible to eliminate all possible sources of failure, we instead build systems that recover from failure and keep processing to meet the mission for which they were deployed.

All Service Grid software is designed to be secure and self-healing. Our Survivable Applications can recover from partial or systemic failures no matter what the problem source, from application to OS to network to building. And by building reliability and security features in at the most basic level, the invention provides these capabilities without sacrificing flexibility, power, or scale.

Ellipsis provides a unique adaptive architecture to manage the capture of data and business information. Supply chains are highly distributed. Ellipsis provides for data capture and business processes at physically diverse points.

Ellipsis is highly distributed, very scalable and highly redundant. This combination of characteristics is unique to RFID software.
Ellipsis is deployed on a computing “grid” that incorporates all the physical locations of the dispersed supply chain
Users can easily add new computing units when, where and as they are needed. The Ellipsis system can grow as large as may be needed.
A single point of administration permits users to deploy Ellipsis from code repositories to all locations enterprise-wide with a single command.
Management agents that Ellipsis disperses throughout the system continually monitor the health of the components and act to restore order. Accidental failure, or even sabotage, of servers, networks, and facilities, does not halt or delay overall processing. The Ellipsis system automatically discovers any failures and regenerates applications on healthy facilities.
There is no vulnerable “Point of Entry” to the Ellipsis system. Ellipsis software is distributed, remotely loaded, and only resident during processing. As a result, it eliminates “point of Entry” system and application attacks. This architecture means that Ellipsis will meet or exceed the standards set by the Department of Homeland Security.

With Ellipsis, data is always available when and where it is needed. This happens because Ellipsis includes virtual agents that represent structural and historical data and policy and business rules. These agents “follow” any tagged item to each location that it will “visit.” This means that:
Ellipsis moves its software and data around with the physical goods, Ellipsis insures Ellipsis' agents' automatic reactions to events and the processes they trigger are always measured and appropriate. Any response occurs immediately.
New features and custom adaptations can be developed quickly and cost effectively. Ellipsis' open architecture facilitates such rapid design and deployment.
General and locally specific rules and processes can be incorporated into Ellipsis quickly and easily. This reduces customer costs dramatically. It also eliminates the need for site specific customization using expensive professional services.

Ellipsis moves the computing power and the application processing to where the “business process is happening.” By moving policy and process to where the things affected by policy and processes are located, we are using the network to connect computing power to business processes in the real world.

### Providing Local Intelligence for Tagged Items

Service Grid will have generic servers placed near readers. When an EID is read, it is placed in a HIJAS (Heuristic Intelligent JavaSpace Agent Subsystem) system that includes an XML JavaSpace or other Tuple-space. The class and specific identity of the object is interpreted by the system and a remote lookup of the item's master agent is made from the global distributed data service. A clone of the master agent is remotely transmitted into the generic server and placed as client to the HIJAS. The item's agent is now local. It contains the history of the tagged object, all the past locations, where it is to go, how it should respond to choices, what the system should do if the item is ‘off track’.

This Agent follows the item about as it moves through the supply chain. It keeps its remote master copy synchronized. When the item is read in a new location, the buddy is cloned to that new place and the old buddy is read into permanent storage. The item is no longer just type, vendor, and serial number. It has a brain that follows it around.

See FIG. 4: The Internal Objects of an RFID Agent

The Agent can be encrypted and secured. It can provide features such as non-repudiation to location reads and actions taken on the items behalf. For business, this means that as the item enters or leaves a new warehouse the movement into the location cannot be altered and can server as a financial transaction. Service Grid provides for micro accounting between the agent and the container and between the container and master accounting services. These can take the form of milestones, budget credits, or micro-currency flows. The item has security as well as identity.

The Agent can be encoded with policy. Usually these are ECA (Event, condition, Action) statements. When an even occurs, a condition is checked and if met, a specific action is initiated. Actions can be quite varied and range from simple to complex. A complex action could be a multiparty distributed transaction with alternative branches based on different transactional failures. Business example would be triggering a remote check with the home office if the item is located in an area where the temp exceeds parameters, and flagging of the Agent as item-depreciated if no continuance code is returned from the home office. The item has flexibility as well as identity.

The Agent is created when the items comes into existence in the system. Everywhere it goes and everything that happens to it gets encoded in the agent and its remote master. Its history becomes permanently attached to the item and is always locally available. Complex information of almost unlimited scope can be maintained and acted on locally. The tagged item has a history, memory as well as identity.

The Agent does not live alone. It lives in a population of other agents. The tagged items can be built into dynamic associations, a virtual representation of it place in a physical system of other items. Such an association can be a pallet of crated RFID tagged boxes, or a shipping container of such. It can be a complex assembly like a machine made of separately tagged parts. It can be an assembly line. These associations are external to the agent but understand the associated agents. The associations can be made and broken in real time. Business actions can be made on the aggregate agent structures as transactional semantics. So the tagged item is not alone, it is in a physical and business system.

The Agent lives within the Service Grid environment. This Mirror World of services can provide complex business support. Every Microservice in the global system can be called upon to provide extended functionality when needed. So, although an item has only identity information from the RFID tag, it gains an enormous amount of contextual and policy-driven intelligence from the software.

### Adapting to Evolving Technology

Continually, RFID hardware vendors are pushing new technologies into the enterprise market. These include dumb EID tags, environmentally sensing tags, encrypted tags, and tamper-proof tags—and we know more are around the corner. However, when big enterprises buy these they find that the cost of integrating, servicing and maintaining these RFID systems could be as high or higher than the cost of the devices. These enterprises and these emergent prolific vendors both need a fast, secure way of integrating these new tags and reader devices into enterprise IT networks and the ‘network of things’.

When new tag technology does become available, it continues to cost the enterprise. Existing applications are inefficient and require a large expertise on the part of the application users. This kind of staff is hard to hire and hard to retain. When problems do occur, the down time is extensively and costly.

### Putting New Technology into the Enterprise

But RFID applications are just part of the solution. The reason for an enterprise ‘network of things’ is so that things, applications and users can work together over the dispersed physical presence of the enterprise. So the problems with adding RFID technology and managing these are duplicated for adding RFID applications and managing them. Then there are the computers, the servers, on which the RFID applications run. The RFID technology and application vendors generally have no concept and plan for ongoing management of the applications and the computing network. To them, the applications are just processes running on the servers: there is no inherit knowledge of the needs and limitations of the application. The history of products has evolved so that this server/process problem is a separate industry product group.

Then there is the problem of adding new users and new applications to the existing mix. Entirely separate application groups manage users, personnel and staff from those that manage RFID technology or vendor software applications. Most of these existing solutions are quite static. Generally there is no awareness that a network even exists in these applications. However a different product group has begun to match users to applications services (Service Management products.) They interface with services to configure them for new users and new locations, but this is very generic with no awareness of any special needs of a ‘network of things’.

None of these diverse approaches provide for a long sought ‘holy grail’: how to automatically make the applications and the network adjust to adding a new user to the system. They have not begun to approach the parallel problem of adding a new tagged device class to a network and keeping track of each individual device—Or associating the specific serialized device to a specific person. Even the problem of associating users with locations, duties and equipment, partially solved today, does not extend these solutions to the tagged items moving by or stored near these individuals.

How do the security authorization permissions and use preferences of the users, in relation to tagged items, get communicated to the applications? How is the remote access to item information of the user established? We know the tagged items move about, what happens when this is coupled to a user moving around a lot; if the user needs access from diverse international locations? There is no automated technical solution for this today—just lots of manual work by scarce experts, time delays, and enterprise frustration. All this is added costs and lost revenue opportunities.

Traditionally the vast problem has been divided into functional areas. These functional areas have become market segments and separate & distinct product groups. The groups require extensive integration to work together. The integration costs eventually equal or surpass the component costs for applications, servers, and network.

Supply chain and inventory management are two of these market sections. These are never related to Network and system management. Configuration management is a way of programming network devices so that they function properly and inter work efficiently. Networks are complex things; configuration settings must also be complex. Many opportunities for error are introduced. Then this combination must become aware of the servers, applications and the users accessing them. Combining these areas is a good place to start when trying to put all the network asset parts together with the ‘network of things’. When this is accomplished, a holistic management solution emerges for users, applications, networks, and the extended domain emerging as the ‘internet of things.’

### When Things go Badly Wrong, Very Fast

What if the ‘bad guys’ target this system? Individual application systems will be lost or isolated. Integrated solutions that do exist are cobbled together products and are therefore fragile. Readers can be isolated from inventory, supply chain and other business applications. Warehouses can be cut off.

To control for many variable factors and costs (see Enterprise Resource Planning), the applications and servers are usually gathered into just a few big data centers. This means the system is subject to security attacks. Current solutions, like firewalls, are just band-aids which keep out only the dilettante; not the determined intruder. But worse, what if someone gets access to a data center with a bomb wrapped around his waist. What if someone flies an airplane into the building? What if someone attacks a neighbor, shutting down the local area even when no direct intrusion occurred?

In the future, enterprises must become aware of some long standing military concerns—C2: Command and Communications. Enterprise IT organizations must perform better than even NASA does. Generally this concept is called mission assurance. It is the promise that no matter what the attack, the applications will continue to perform. Mission assurance is a combination of Security measures and high available applications. Both these come at high costs and reduced IT performance. High Availability generally means hot standby locations which more than double costs of IT. Security means slower applications, more network traffic, constant vigilance.

### The Frictionless Solution

How could there be a better world? What would it look like? Lets consider for just adding new RFID technology.
Adding any new reader device and/or item class would take only a few weeks for the IT vendor and hours for the enterprise customer.
You could buy and integrally manage any device you wanted, even bleeding edge technology
All the equipment settings, the reader configurations, the software deployment, the equipment system parts and the equipment placement would be found and saved by the product
Configuring a new reader device would be automatic—plug and work
The system would detect changes and automatically revert to the approved configuration—unless the change was authorized or the command excluded from protection.
The system would respond in the proper context of time, place and businesses goals and as these vary the response varies (policy)
The system would intercept equipment and system alarms and fix the issue; then send a status message to anyone interested
Any authorized staff could subscribe to whatever event was of interest to them and have it delivered to whatever network appliance however they were connected to the network.
One command could start a new RFID technology network up from scratch, deploying the management applications and configuring all the equipment.

The local solution: frequently tagged items and network assets are not near management assets. The network is out there where the supply chain, warehouses, and retail centers are: in the transport, factories, and buildings. Traditional applications are in the data center and must reach out to manage readers and tagged items. This reaching out can add billable enterprise network traffic; it can add delays that become significant in globally dispersed enterprises. Imagine a solution that deploys itself into hardened servers located alongside the reader equipment. When something goes wrong, the response is local and immediate. When a change is needed, causing code or data to be adjusted, then in a matter of seconds, the adjustments automatically propagate everywhere in the global network.

Making the user a part of the solution. What if the network knew how everyone was connected to the network? If it knows how to connect to whatever appliance they were using: workstation, laptop, PDA, or phone. If the user was not actively of line, the system could find that user and initiate a connection or communication. If a virtual representation of the user were always active and running in the system, an application could always find and interact with a user as easy as users could find and interact with applications. When the user is represented in terms and ways programs can understand, than the network can adapt to the user. The user becomes a service with a programmatic interface. When location services are added, when locations of RFID tagged items are added, the user enters into the ‘network of things’. Users can find things and things can find users. Things can uplink themselves to users, making users aware of where the thing is and how it can be used. In wholesale terms, spontaneous work items get associated with local users. In retail terms, advertising and up sell become possible.

This software invention:
Moves where it is needed
Recovers when the connection breaks
Recovers when the server dies
Is always up to date everywhere in the world
Understands its users
Understands the tagged items
Understands the devices
Understands the network.

### Immediate Advantages

Truly Distributed—The supply chain is a naturally distributed problem with data capture and business process occurring at many physically diverse points. Tying these remote installations into large centralized computing centers introduces significant delays in processes, enormous costs and exposes business goals to unreliable networks. By moving software and data around with the physical goods, Ellipsis ensures they are always available when and where needed.

Survivable—Accidental failure or sabotage of servers, networks, & facilities will not halt or delay overall processing; the system will automatically discover the failure and will regenerate the applications on healthy facilities.

Secure—Ellipsis will adhere to or exceed the standards set up by Homeland Security directivities. Microservices meet the highest security expectations; being mobile, they do not provide a stationary hacker target; if ever compromised, only a partial application is affected and the system isolates it and heals around it.

Deploys easily—because all code is remotely deployed to match an external, pre-configured profile, companies will be able to bring on new locations with no effort, cost, or downtime. Upgrades are automatic and continuous. This translates to cost savings that grow in direct proportion to system sizes.

Ensured Data Access and Integrity—Remote data is more accessible, freeing companies from reliance on the Internet. Data “follows” the tagged item virtually and resides at each location that items “visit”.

Reduces Integration Costs—Advanced EAI platform makes legacy integration much less time-consuming.

### Mid-Term Advantages

Creates Business Objects with Precise Policy—Ellipsis creates business objects that are software virtualizations of each tagged item. Each software object contains both data about the item and complex policy and rules that are constantly updated throughout the business lifespan of a tagged item. Because Ellipsis code and item data follow the item into local reader environments, reactions to tag reads and to local environmental changes are both immediate and precise. No data is ever misplaced, lost or contextually incorrect.

Flexible—Simple rules are used to quickly build universal and local policy and processes, thus dramatically reducing the need for customization by professional services contracts. Ellipsis customers can make changes to business logic dramatically faster than with any competing system.

Scalable—Ellipsis is deployed in a ‘stage three computing grid’ infrastructure. A stage three grid, often called a service grid, is about moving the computing and the data to the areas where business process are occurring. The Ellipsis architecture makes computing more congruent with the real world and less driven by the historical trend of centralized IT resources. Ellipsis spreads the grid into the active areas of the supply chain. New units can be added to grow the system as large as needed, even to supercomputing levels.

Lower Development Costs—Ellipsis lowers costs by reducing the time needed for development, testing, deployment, and upgrades:
The Ellipsis communication framework allows developers to focus on business logic rather than the complexities of the communication layer.
Complex applications assembled from small, reusable Microservices. This dramatically increases code-reuse and efficiency.
Business intelligence defined with rules and policies; not complex multivariable exception handlers and flow-charts.
Single point of administration enables deployment from the testing environment to all locations enterprise-wide with a single mouse click.
Version control and dependency tracking are automated, making upgrades and ongoing lifecycle changes automatically.

### Long Term Advantages

Lower Total Cost of Ownership—Ellipsis removes the need to purchase dedicated, expensive clustered hardware. Because Ellipsis servers are deployed and maintained on a ‘utility’ model, administrators can focus on just the Ellipsis management interface instead of struggling with the underlying operating system. This approach decreases the labor costs necessary to maintain, grow, and change an Ellipsis installation both up-front and over time. It also increases security and replace-ability. If an Ellipsis server fails, it can be replaced with a generic copy kept on-hand or drop-shipped when needed. The replacement need only be plugged in and switched on; it will automatically find and configure itself like its peers, join the grid, and get to work.

Network Effect—When supply-chain partners deploy Ellipsis they are able to share sophisticated policy data regarding inventory that is simply impossible with any other system. Refined knowledge and policy gained at one location can be passed along to other supply-chain participants. This creates a powerful incentive to recommend the system to trading partners.

### Exemplary Implementation

The implementation described herein is based on Java, Jini, and Javaspaces language technologies. However the same services can be delivered using Microsoft Corporation's C#and “.NET” extensions which provide facility for programming development of leasing, containers, look-up services (UDDI or other), and tuple-spaces. Generally, any software language group which provides for serialization and marshaling of code over network connections can work. Any underlying transport protocol can be used.

It is possible to implement this invention using standard mobile agent systems which rely more directly on TCP/IP, including IBM's Agelets system—what is required is a mobile agent structure and a generalized container model. It is even possible, albeit rather cumbersome, to implement this using standard compute grid methods which rely on file sharing systems and application servers.

### Further Example Homeland Security Applications Using Service Grid

The invention description concentrates on commercial supply-chain business process examples. However the technology is equally suitable to a wide range of information technology problems in automation and response to location triggered and event-based messages. While I describe the supply-chain exemplary implementation, this invention applies to a much wider field. For example:
Survivability of business and government service applications during attacks. For example, if a data-center is bombed, the applications automatically relocated elsewhere in the grid network and continue processing, usually in seconds.
The Service Grid is ideally suited to the new practice of ‘Distributed’ Command and Control (C2). Team members have network based agent avatars that represent them virtually. These can be used to self assemble teams and coordinate team communication. Like-wise teams have team-avatars which link to form larger control teams. Distributed Microservices mimic distributed command structures.
Fast-reaction teams can be assembled in moments by picking the correctly skilled members from the pool in active contact with the network (via terminals, cell phones, wireless PDAs, etc.). Members are selected to insure the full skill mix and experience required and invited to join a secure group group-space. Everyone can intercommunicate via this group-space and access accumulated data. Processes are invoked automatically by events, controlled by state-machines and processes adapt as circumstances change.

### DESCRIPTION OF THE DRAWINGS

FIG. 5: Prior Art for RFID Middleware is a flow diagram showing 3 views of prior art in RFID middleware. The top view presents the information flow around reading an RFID tag as envisioned in the idealistic Auto-ID center's “Internet of things”. In the middle view, this idealistic view is being replaced in actual implementations by a practical integration of the supply-chain methods in practice for barcodes with the reader-side features of the Auto-ID architecture. The bottom view highlights the requirements for integrating a mime-mail transported EDI manifest with the information from a tag read as an added burden on RFID middleware systems. In market practice, the heritage supply-chain products are extending themselves with satellite edge servers which just read and verify, passing the information back to the ERP structured heritage product core which retains all the business process computation.

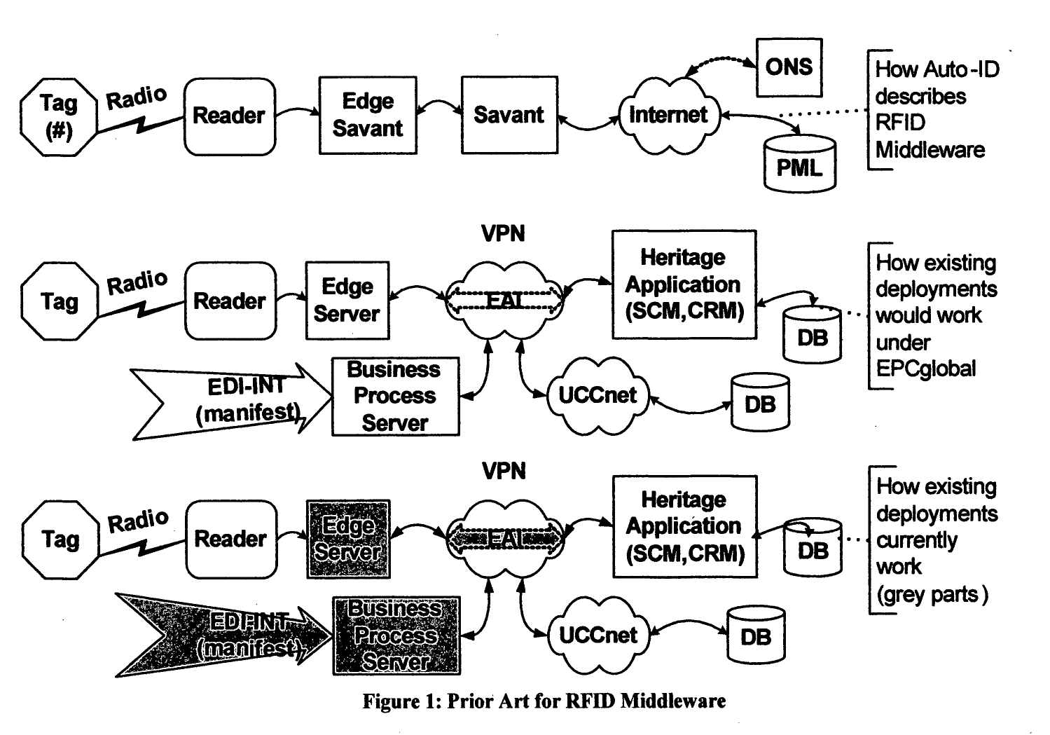

FIG. 6: Supply-chain is naturally, physically distributed is a cartoon illustration of a simplified supply chain. Flow moves left to right during the life-cycle of goods in outward distribution. Supply chains are geographically dispersed, often global in scope. They are not usually connected by common networks. No, easily predicted path exists during the real world transit of goods where environmental and work conditions are constantly changing. Current art is to predict the flow of goods for purpose of optimizing routes and then using business processes that are at arms length to direct this flow. Often the transport processes at the edge are not automated. A novelty of this invention is that it architects a solution to the physically distributed supply chain with a physically and logically distributed business services grid, placing that grid throughout the supply chain.

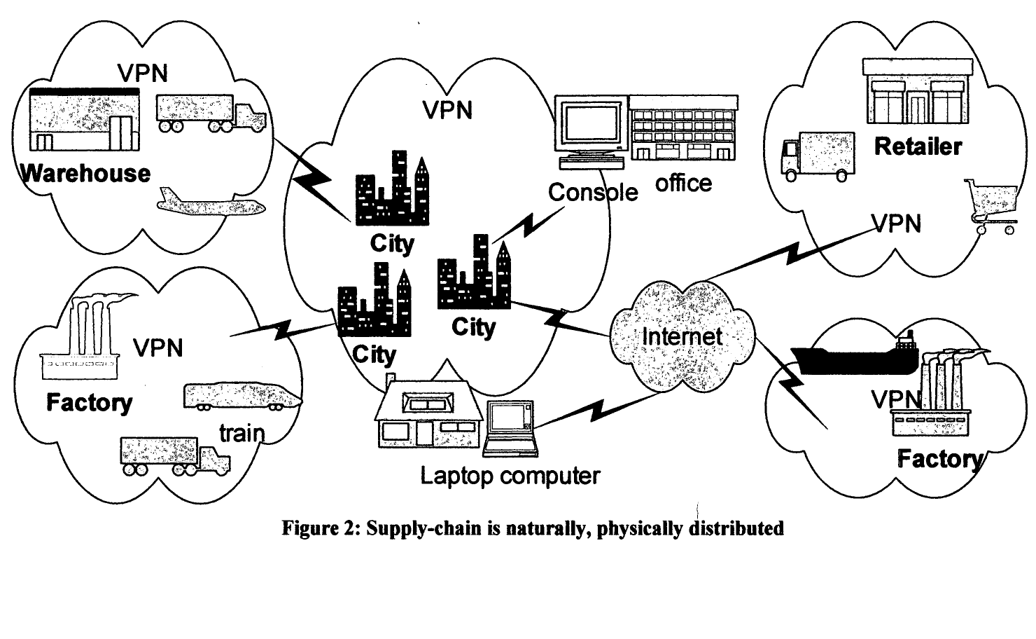

FIG. 7: RFID agent follows tagged item through supply-chain is a flow diagram that presents a cartoon of the RFID agent moving with the RFID tagged package item. This is a central novelty of this invention. Instead of gathering reader data (Id, time, location) and shipping it back to massive, centralized, ERP supply-chain applications, the information is bundled into an agent which moves with the tagged good; following in the virtual space of the service grid.

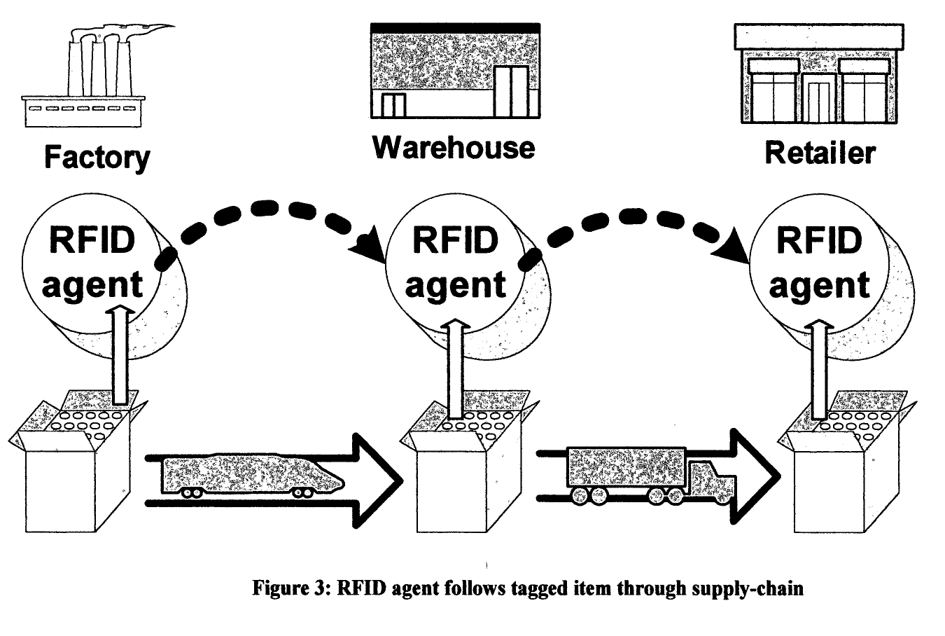

FIG. 8: Agent associates with tagged item via tag Id as read by RFID reader is a more complex version of the cartoon shown in FIG. 3. For the mobile agent approach to function properly, there needs to be an association of the ID in the RFID tag with the name of the agent. The invention uses XRI in the agent for this. There also needs to be a business Service Grid which involves computers placed where the tagged item will travel and a network that connects these locations. The RFID readers in the supply-chain locations will connect with the local computers which are a part of the service grid.

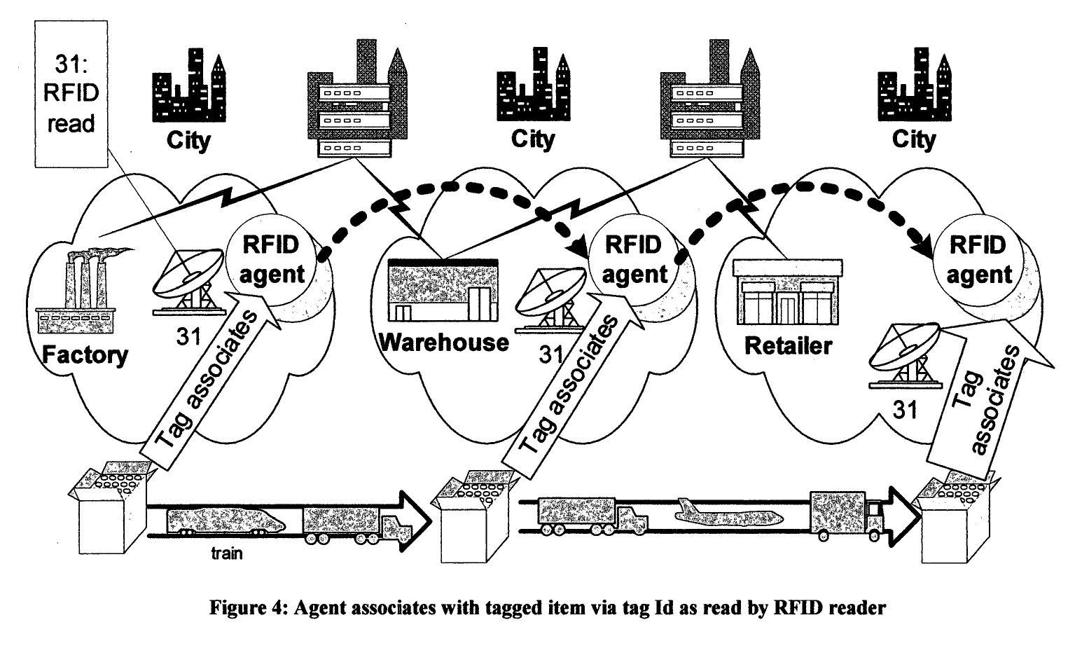

FIG. 9: Forward deployment of Ellipsis into supply-chain is a cartoon diagram which takes a system perspective of the same business space of FIG. 4. Ellipsis is the name of the exemplary implementation of this invention, represented by a donut (a space) & agents (bits of rim). Here you see that the software system is dispersed throughout the supply chain. It establishes connections to all actors in the supply-chain process flow. The edge mounted Ellipsis (HIJAS and agents) interconnects with a distributed set of servers hosted throughout the global enterprise, which we call the Enterprise domain. Most utility services and persistence occur in the distributed enterprise zone. Business processes are implemented in the many edge Ellipsis system domains. Program code and data move through this distributed system. The many nodes of this system are connected through a Virtual Private Network (VPN) established over many possible physical networks.

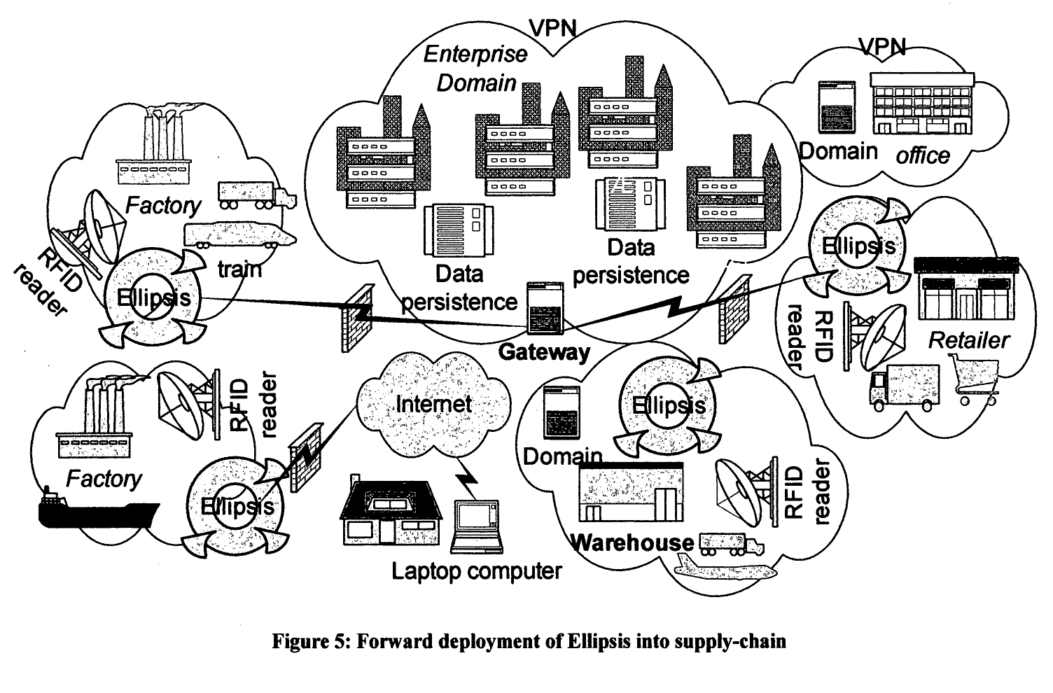

FIG. 10: Prior Art—Tuple-space implemented as Javaspace is a diagram of a tuple-space, showing the illustration icons used throughout these drawings. Tuple-spaces are well known at this time. The forward deployed Ellipsis domain systems have a tuple-space at their core which is used to coordinate communications among the RFID agents and the local business processes, policy, and utilities.

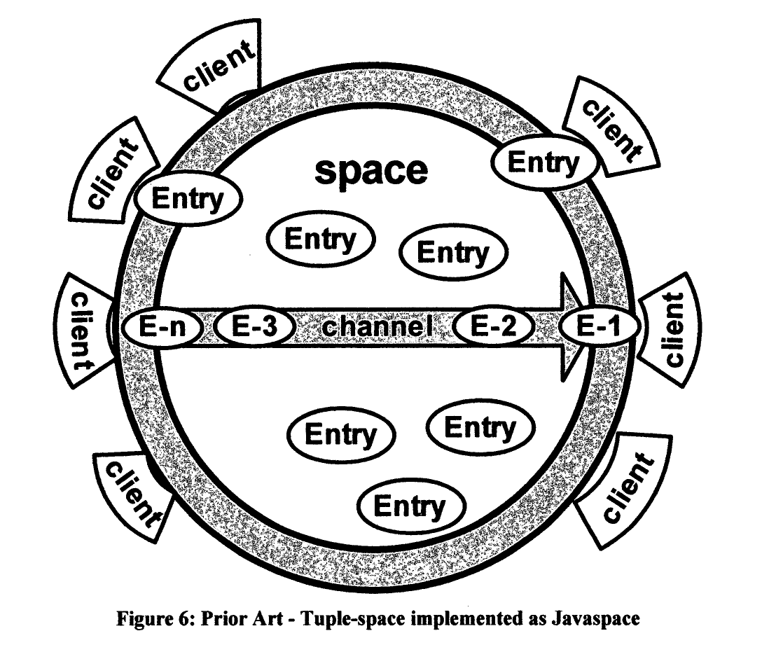

FIG. 11: Remote deployment of a tuple-space and associated client services is a diagram showing a specific requirement of the tuple-spaces for Ellipsis, is the ability to have them remotely deployed (as all services in the ecosystem must be.) only some of the tuple-space products in the market have these properties which allow them to be fully encoded in a JAR file. Further this illustration shows remote management of the tuple-space by an agent system. It shows that for survivability, the entries in the tuple-space must be replicated to one or more remote tuple-spaces. The management of the attached clients, the tuple-space itself, and the replication of entries, must all be coordinated. While each of these activities and components is in itself not novel, putting all these together in an integrated subsystem is.

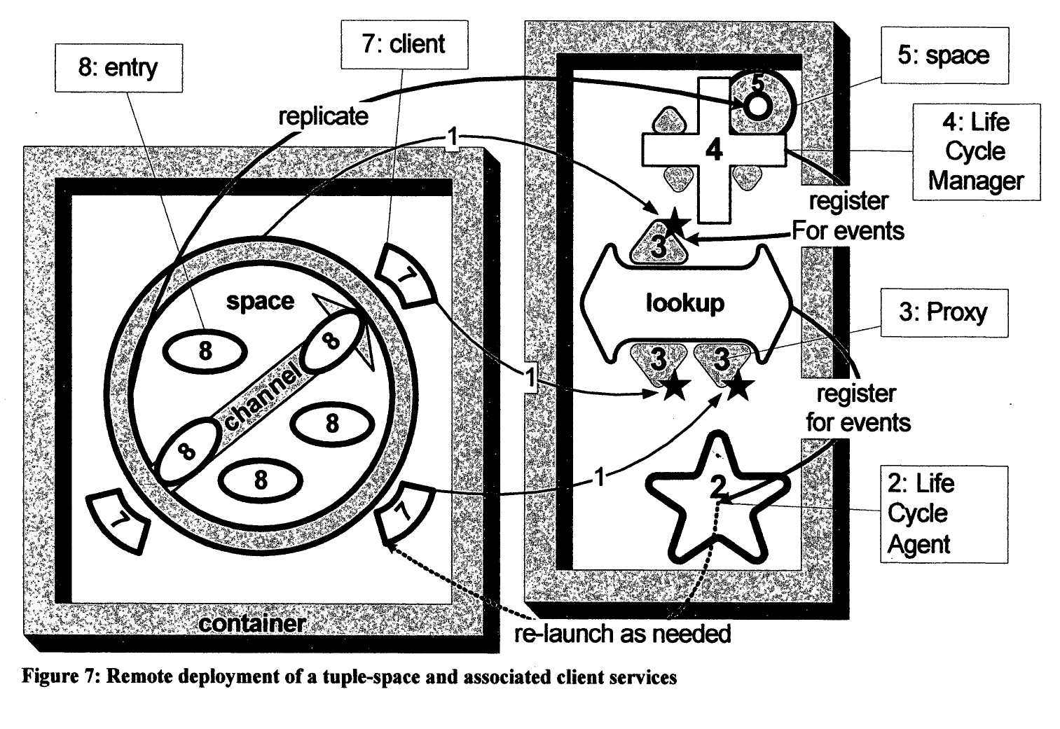

FIG. 12: Regenerating a tuple-space upon failure, thereby providing survivability is a diagram showing the flow activities of recovery from a radical system failure at a forward, tuple-space centered domain. The lower right container shows the dead tuple-space (caused by failure at any of: software, computer, or network). Using the replicated entries and the ability to remote deploy a tuple-space, a new tuple-space is launched, the clients regenerated as needed, and the Ellipsis domain system continues as before. While each of these activities and components is in itself not novel, putting all these together in an integrated subsystem is. This recovery, regeneration processes is used for all container deployable services throughout the Service Grid.

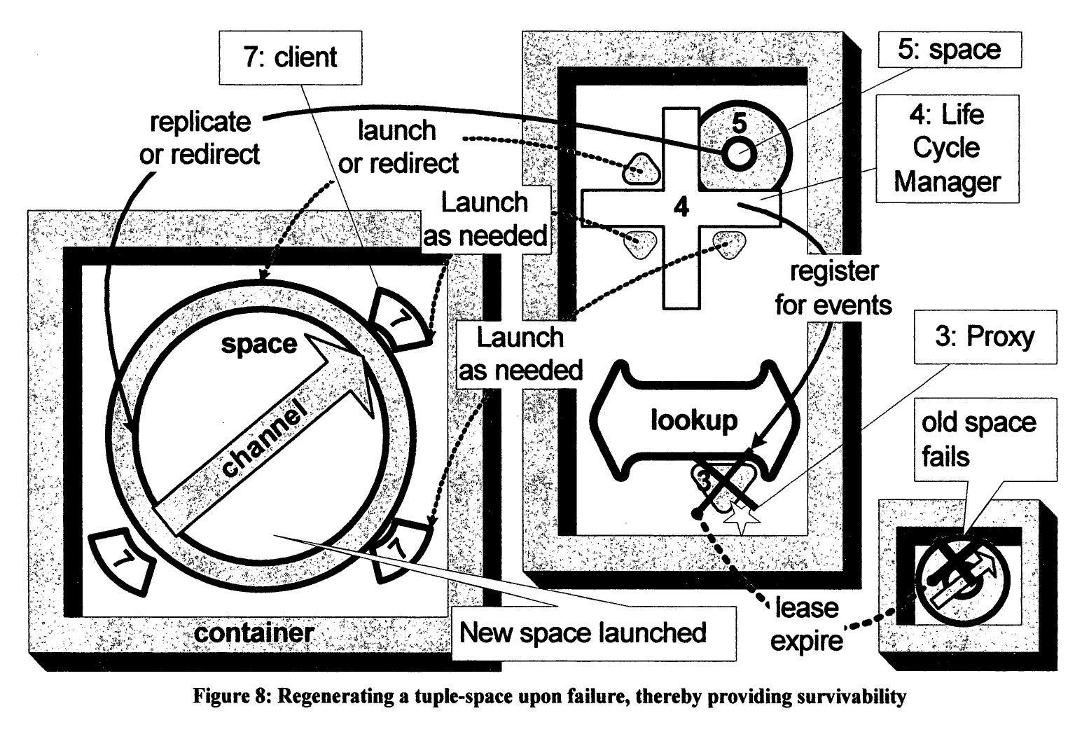

FIG. 13: Derivation technologies as utilized in a Microservice & support systems is a diagram which further illustrates the symbols used in these figures. At the left is the illustration of a Container. Containers host services. In the middle is a service which will fit into the Container. Many Microservices will be in a container. On the right is a life-cycle manager, a specialized service which launches and watches other services. Using Containers, services, and management services is not itself novel. This invention provides novelty in the enrichment of these software artifacts with specific functions and features of much different, prior Information Technology (IT). This diagram shows how prior art containers, services, and managers have been specifically augmented with these diverse IT features. For example, Authentication, Authorization, & Accounting (AAA) is otherwise implemented (in prior art) as an external application; in this invention the functions of AAA are embedded in the container and linked to utility management and accounting services. So also Kerberos is embedded in the container allowing secure remote launching and management of this layer. These containers are embedded with grid management interfaces as are the management services; this enables the uniform distribution of these services on a computing grid—a novel implementation of prior business service grids (which tended to be static web-service and application server implementations.) The result of these embedded augmentations to prior art is extremely novel and extraordinarily facilitative of distributed computing in a grid.

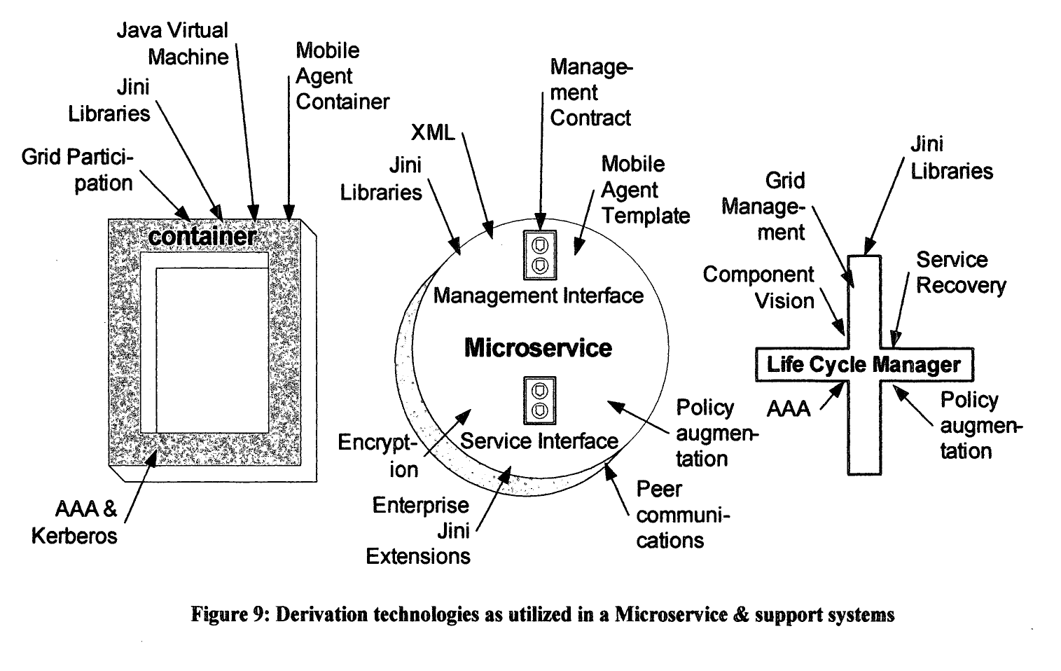

FIG. 14: Inheritance of major types of Microservice is an object inheritance diagram showing the topmost object-oriented derivation of services. These are provided as libraries. From the basic Microservice, specializations and augmentations provide the two basic templates for Service Grid Microservices: the mobile agent Microservice (implementing an enterprise Jini remote service interface type) and the Javaspace-attached Microservice (implementing the javaspace interface). All these inherent the basic features of a core Microservice including both service and management interfaces.

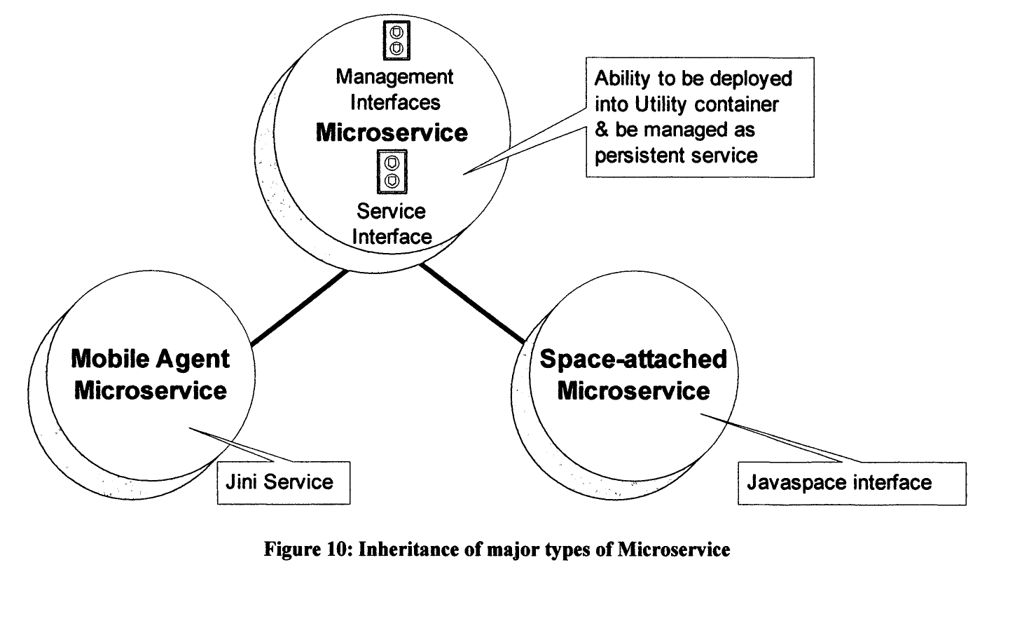

FIG. 15: A Policy Agent is a specialized form of Microservice is a schematic illustration of the production of a Policy Agent from the core of a Microservice. Specifically designed to be built with Rapid Application Development methodology, the kernel is a group of Event-Condition-Action (ECA) statements, a specific way of representing rules for policy. The kernel has an internal, local interface to the mobile agent. The agent has a generic policy interface which other services can discover and invoke using either interface-template matching or meta-language XML/XRI. Prior art has behavior services implemented as a heavy-duty remote service, often a rules engine comprising thousands of rules. It is extremely facilitating to have the rules dispersed where they can be invoked via service discovery.

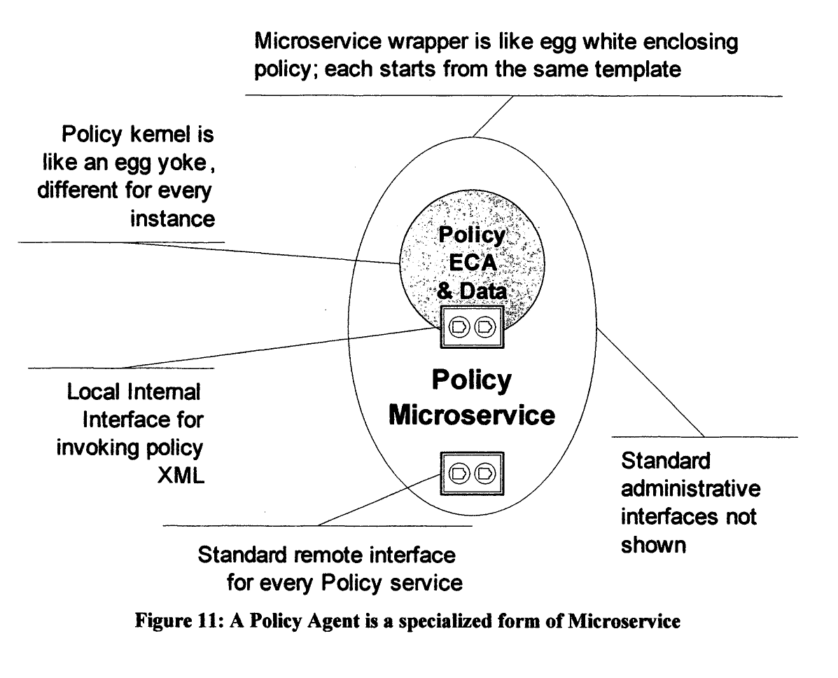

FIG. 16: Microservice with Service Grid support services is a diagram showing the Microservice associated with its management agent and registering with the look up service using typical Jini proxy technology. The use of Jini, look up services, and management agents is not novel. However, the Microservice has been fitted into this general approach to distributed computing.

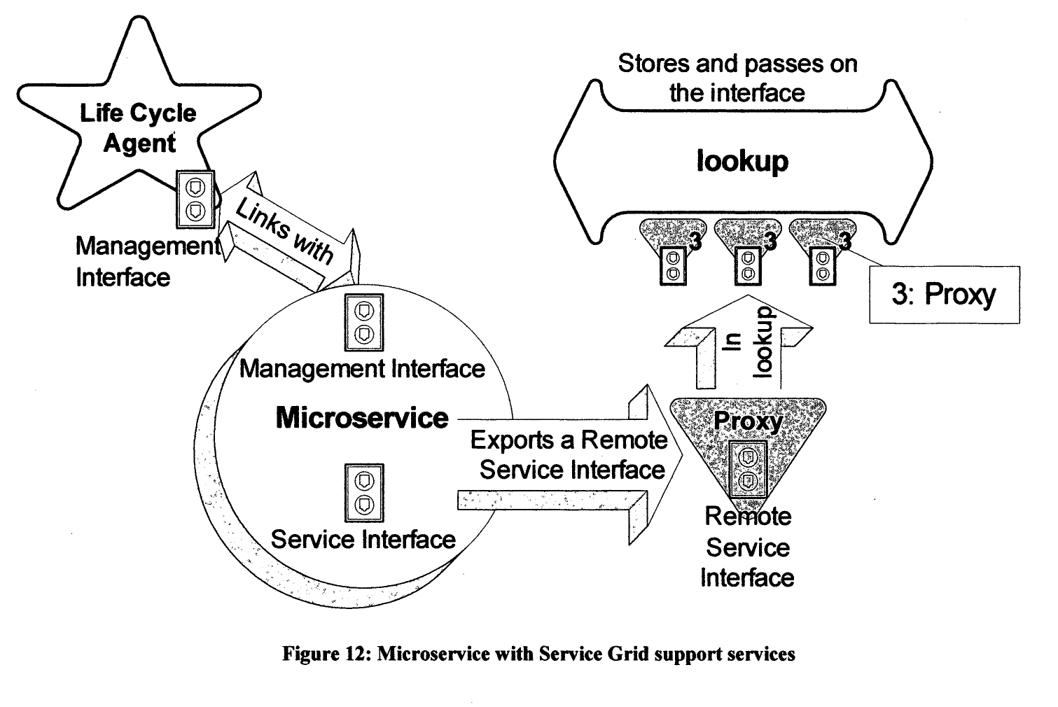

FIG. 17: Microservices find and link with other Microservices to form a Community is an illustration diagram showing a group of Microservices associated into a community. The actual pattern of Microservice to Microservice linkages will vary with each business or utility. In prior art, services, even in distributed ‘Jini-like’ systems were major applications which provided rich and varied functions. The Microservice community breaks down these large services into many piece-parts which are them selves distributed. These distributed Microservices find each other and associate into communities which functionally take the place of traditional software applications (products). For simplicity, this community is shown associating with one management agent, in actual implementation, several agents would be used, where the agents have no direct knowledge of each other or inter-association.

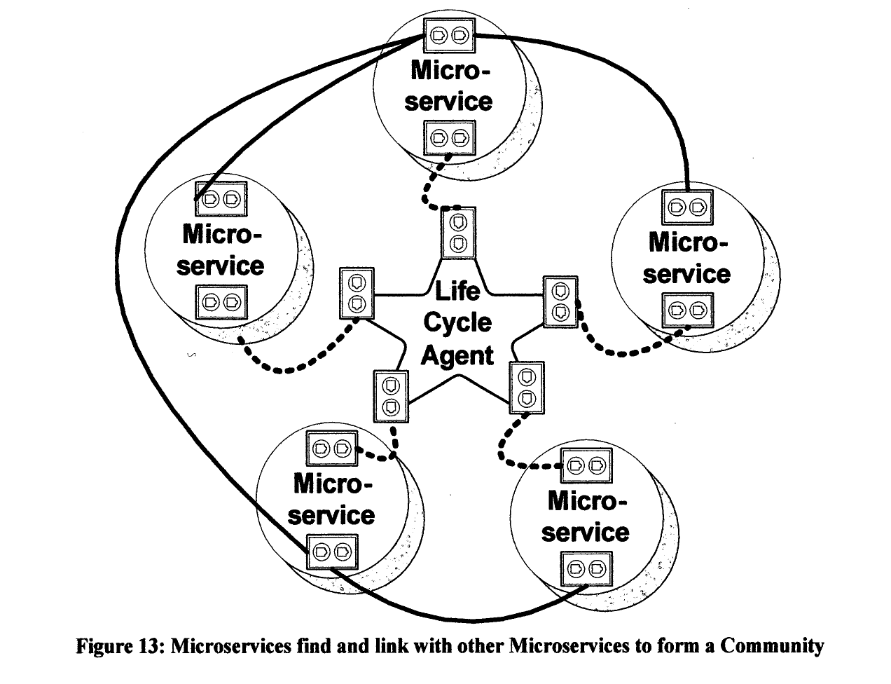

FIG. 18: A single Microservice will implement the Component Interface, fronting for the component community is a diagram showing a community of Microservices which have implemented the functionality traditionally held (in prior art) by a monolithic major Component (as with OMG and NGOSS architectures). One Microservice implements the external well-known and stable Component Interface, acting as a ‘spokesman’ for the community as in the Façcade design pattern. This greatly simplifies the interfaces a developer needs to learn to use and implement utility, administrative and pre-packaged business component services.

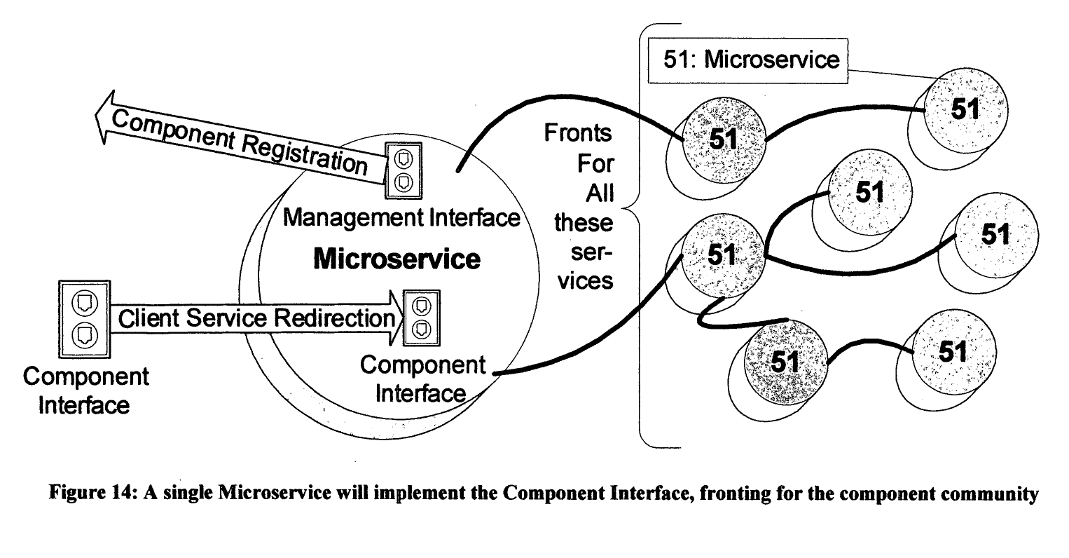

FIG. 19: The Service Grid is a collection of services deployed on a network of distributed computers is a cartoon diagram showing the virtual and physical parts of a Service Grid. The virtual/software part: Business and Utility services are shown in containers to the left. The physical grid of computers and network is shown to the right. The containers run in computers everywhere in the grid. The Service Grid is usually deployed over a wide geographical region for security and survivability characteristics; but can be grouped as desired. Thousands of computers and tens-of-thousands of services can participate in the grid allowing scaling to supercomputer equivalent processing levels.

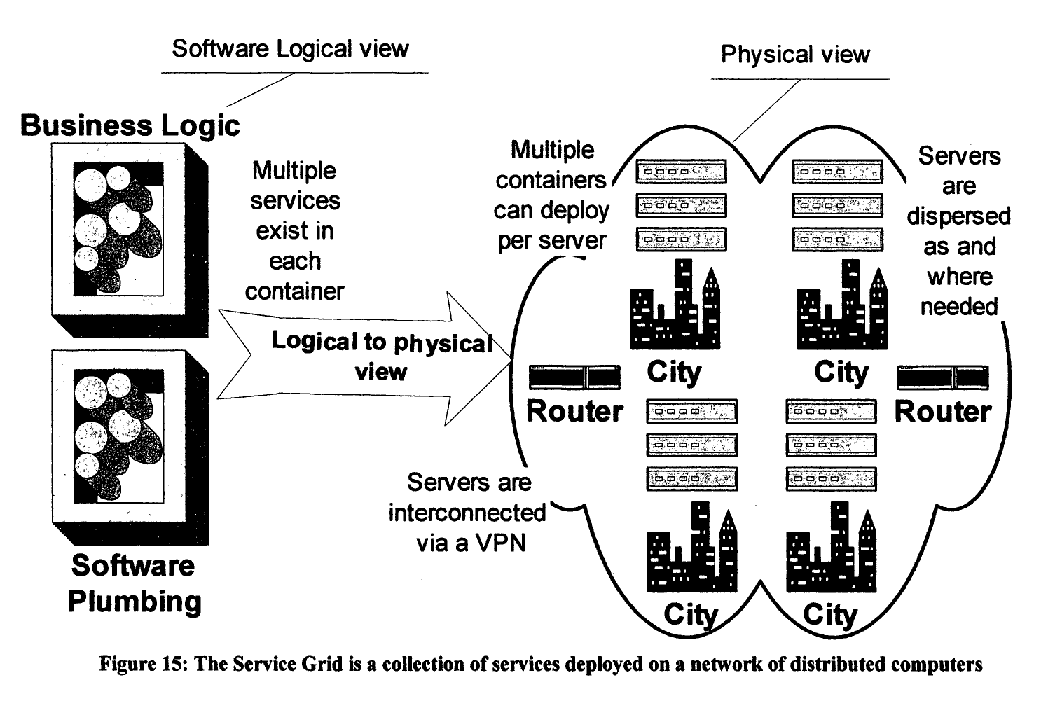

FIG. 20: The internal objects of an RFID agent is a cartoon diagram of an RFID agent group. The agent is a Microservice with both mobile-agent and space-attached properties, as well as the policy agent. The RFID agent group comes itself is several specialized Microservice versions. Shown here are the major facility augmentations that allow an RFID agent to be a virtual smart card for a simplistic RFID tag. Also the policy core which allows the agent to transport businesses process rules from location to location.

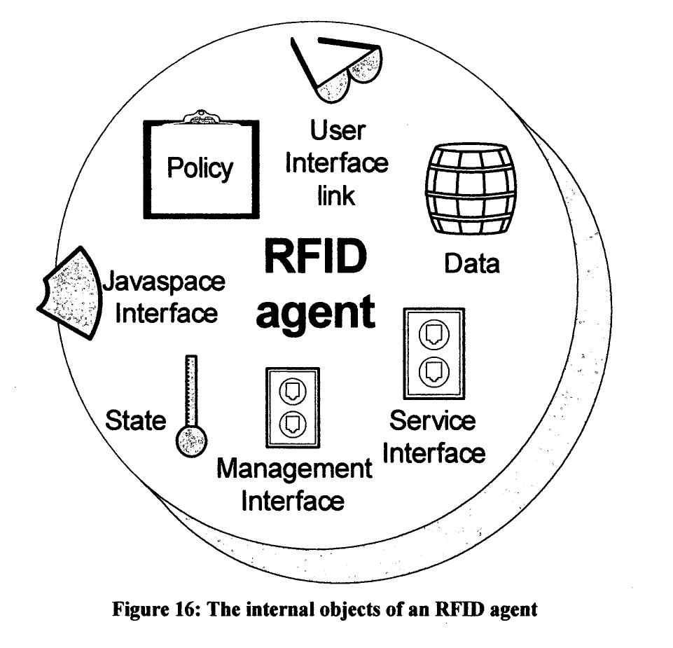

FIG. 21: The Agent resides in a container but associates with a tag and links to a tuple-space is an illustration showing an RFID agent group with logical association with an RFID tag and interface implementation association with a tuple-space. Here we see the specialized children of an RFID agent: the Ego-Avatar (derived from a mobile-agent Microservice) in the central container; the Ego-agent (derived from a tuple-space Microservice) attached to the tuple-space with linkages from the Ego-Avatar; and the Id-agent which is a tuple-space Entry object. There can be many Ego-agents linked to each Ego-Avatar. There can be many Id-agents for each Ego-agent. Ago-Avatars instances are derived from an ‘item-type specific’ Super-ego RFID agent factory (not shown). Agent-Avatars can clone themselves forming a distributed community.

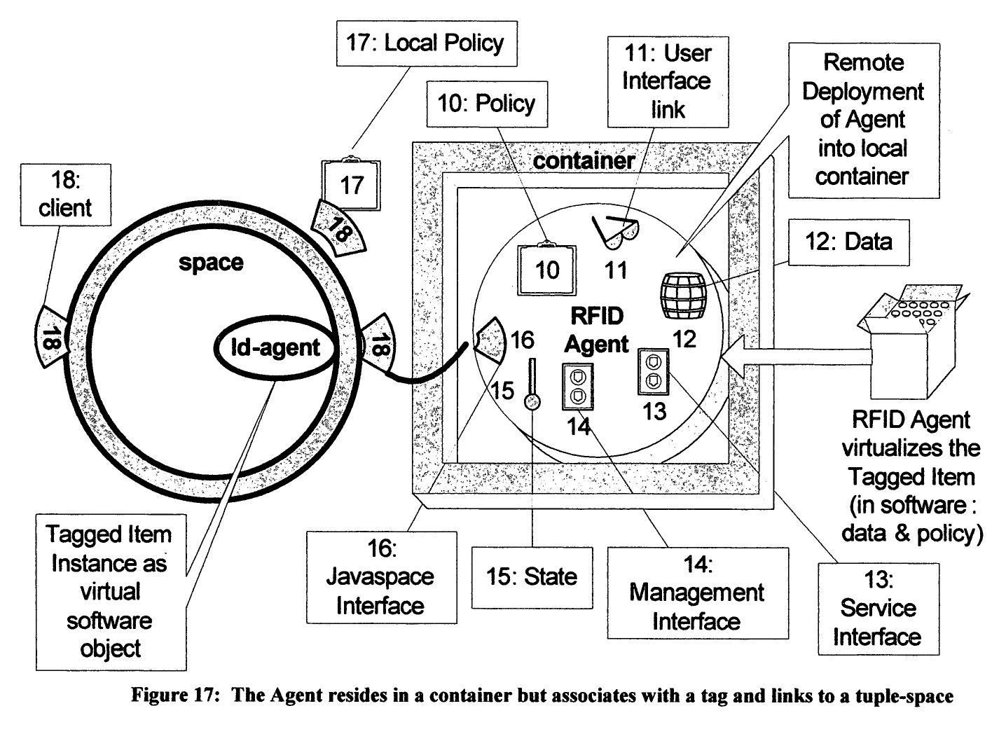

FIG. 22: Anatomy of the movement of an RFID agent from one HIJAS to another is a functional diagram of the process of RFID agent mobility. This is an RFID specialized version of the more general case of the ‘movement’ of any Microservice. While a RFID tagged item is physically transported from down or up the supply-chain (shown at bottom), the RFID agent relocates from the Ellipsis domain of the item source location to the Ellipsis domain of the item receiver location. The agent does not actually move itself as in prior mobile agent art. Here the agent interacts with a 3rd party authentication service (Agent-Avatar) to broker the apparent movement. Actually the soft information (data & policy) is copied from the source RFID agent up to the enterprise and persisted. After authentication, the Agent Avatar invokes the production of a fresh RFID instance of the correct type is manufactured by a factory in the receiver domain. This links with the Agent-Avatar and downloads the soft information for the specific instance. This has the effect of cloning the RFID agent from source to receiver but adds the security functionality of the Service Grid. When cloning is verified as complete, the original RFID agent in the source domain is killed and garbage collected. Generally, when a specific or general itinerary is known (externally or embedded in the RFID agent), this cloning will occur before the physical RFID tagged item gets to the receiver location. The RFID agent clones, attaches to the local Ellipsis HIJAS tuple-space and waits on the arrival of the RFID tagged item—speeding processing. If multiple destinations are possible, multiple copies of the RFID agent can be cloned to each location. On arrival of the RFID tagged item in one location, the other clones are killed at the same time and with the source original RFID agent (generally under control of a distributed service transaction.) The Agent-Avatar with persistence services, also acts as a backup for restoration of the RFID agent in the event of service disruptions.

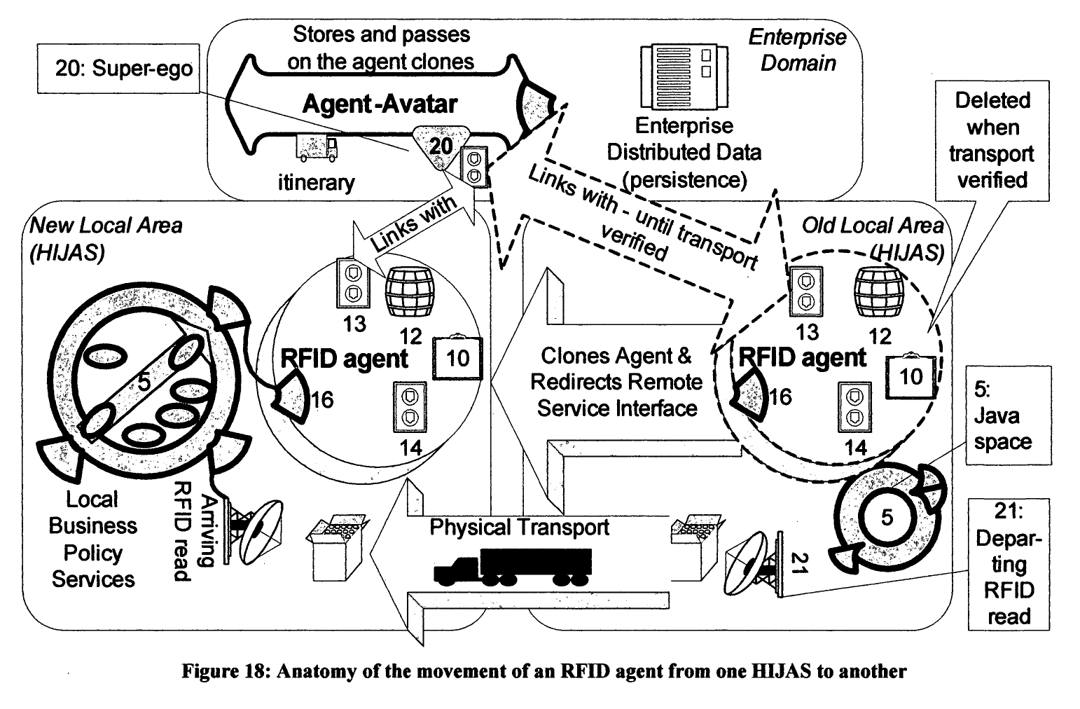

FIG. 23: Architecture of a HIJAS subsystem with its manager and service grid is an architecture diagram of the forward deployed Ellipsis domain. At the top is a representation of the remote enterprise services. In the middle-top of the diagram is a representation of the HIJAS Management Subsystem (HIJAS-MS). This includes the life-cycle manager service and the HIJAS Microservice factories. The Heuristic, Intelligent Javaspace Agent Subsystem (HIJAS) is in the middle-bottom of the diagram. Attached to the core tuple-space are the RFID Agent services as explained above, as well as all the utility and business services which provide for Ellipsis business processes. A HIJAS contains one or more of all these Microservices. In the lower part of tuple-space you can see adapter agents for the EPCglobal RFID tag (EID number) and for proprietary RFID tag implementations. These adapter agents communicate with and control readers which read tags. Flow of the RFID tad ID follows from the tag, captured via the reader, up to the adapter which then puts the id into the space as an entry object. A Master-worker template of control follows. Translators are notified of this new object and one extracts and translates it to generic standard XRI form, replacing an entry into the tuple-space. This is matched to an existing ID-entry or causes the invocation of a search and cloning of the specific RFID agent services into this domain. Asynchronously, other Microservice clients will act on the entries providing specific utility service such as logging or business services such as PLM emulation. Behavioral business process are launched and implemented by action of the placement of these entries into the tuple-space. Complex, adaptive behavior is realized in a forward-local environment.

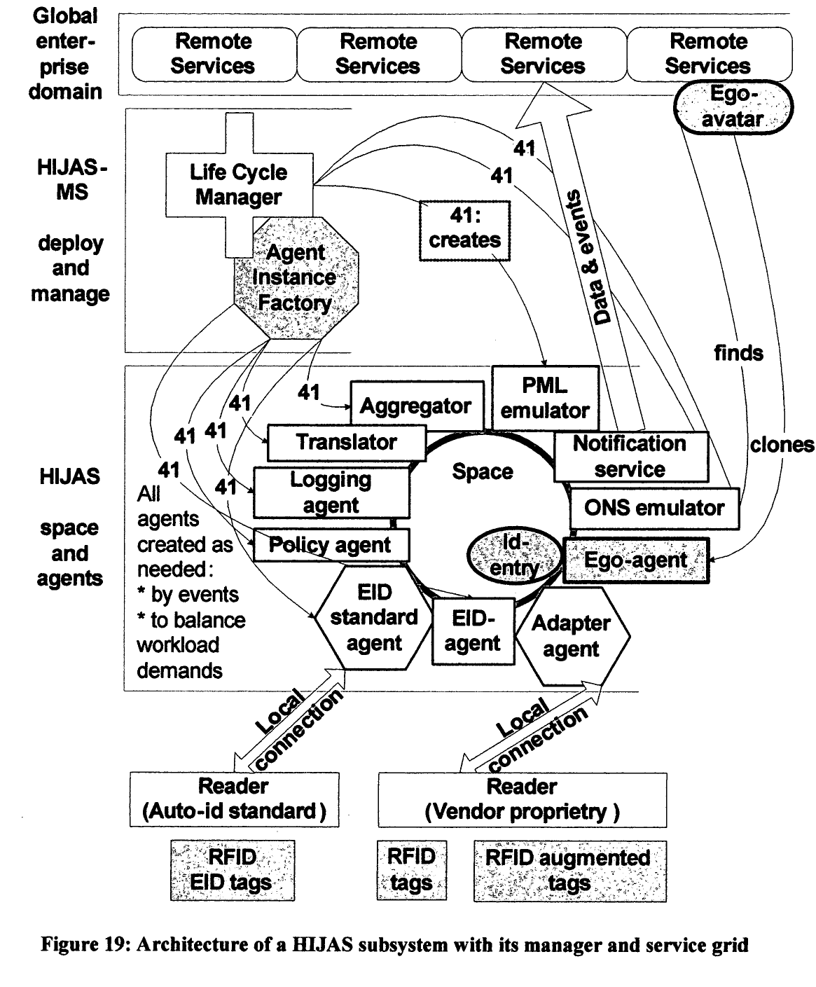

### DETAILED DESCRIPTION OF THE INVENTION

### Ellipsis Overview

Ellipsis provides software intelligence to Radio Frequency Identity (RFID) tags. Utilizing the unique characteristics of the Service Grid, mobile software agents can relocate in close proximity to RFID tagged items. Once associated with the tag, these agents locate nearby and provide local control, environmentally responsive policy, and permanent data capture & history. Ellipsis provides Lifecycle Management of RFID tagged items.

This section explains the unique forward deployment model of Ellipsis, where software subsystems are remotely deployed into servers stationed where readers encounter RFID tags. It places Ellipsis into the larger context of the Service Grid, which is both the platform from which it is built, and the run-time distributed application system that services it. Service Grid is a fusion of Component and Service Oriented Architecture deployed on a wide-area computer Grid.

This section then delves into the ‘mirror world’ virtualization of the RFID agent, a software construct that tracks with tagged items throughout their entire life. It places this agent into the larger context of the Service Grid Components and the specific local services that join to realize supply chain automation and explains the values our RFID Agent provides business organizations are touched upon.

Ellipsis occupies and emerging product marketplace loosely called ‘RFID Middleware’. These applications fill the role of managing and communicating with RFID readers. RFID Middleware turns the multiplicity of RFID tag reads into meaningful Supply Chain events. These applications then provide for local event processing and automation of responses and work activities around RFID tagged items. Lastly RFID Middleware is charged with integrating to other IT applications and providing these with data about RFID tagged items movement, state, condition, and placement.

RFID application systems today come in two groups. Traditional RFID applications use proprietary tags and readers to identify stock, determine location from the reader placement and pass the (identity, location, time) data to Commercial Off the Shelf (COTS) business package software. All systems in commercial use today are like this.

The second group is part of attempts to standardize the front end of the RFID data capture and identification process. This proposed standardization of the field is being supplied by the Auto-ID center, a collaboration of academics (MIT) and industry (retailers and technology suppliers.) The Auto-ID center has taken the approach of using RFID to enable an “internet of things”. Their reference standard for RFID Middleware is called Savant.

Ellipsis can work with or without the EPCglobal or Auto-ID Center's Savant specification. In some cases, it will emulate Savant; in others replace it. This dual approach provides realistic flexibility and needed commercial robustness. For instance, some readers will likely come bundled with Savant edge code. For this case, Ellipsis implements the Savant APIs utilizing these connections. In other cases, Ellipsis must find and fetch basic product data from remote vendor systems that have implemented a PML database and identified it on a global ONS server. But generally, Ellipsis duplicates Savant functions by mimicking Microservice clients that attach to the core Javaspace. This Javaspace provides a stronger facility for routing events and managing tasks.

Ellipsis is agnostic, supporting multiple standards and approaches. It is not dependent on customers and tags adopting the Auto-Id recommendations. For instance, Ellipsis supports the GTIN (Global Identification Code with GBI/B&B DUNS number) numbering scheme as well as others like SSCC (Serialized Shipping Container Code), IATA numbers, ANSI Data Identifiers and motor industry VINS etc. It implements RossetaNet data definitions & B2B flows, TeleManagement eTOM workflows and CommerceNet suggestions. Ellipsis provides translation agents for aliasing products and data from many sources. It will provide connector services to any tag-reader system that provides an interface. Via policy services and collaborative work models it implements many dialogs for B2B and supply chain interaction. With is ability to establish smart gateways to external applications (legacy, heritage, and just market established), it can control the flow of information to and from internal and external business platforms. Ultimately, Ellipsis allows all these disparate systems to be unified in common processes with integrated policy.

### Deployment Architecture

Ellipsis technically differs from prior RFID middleware approaches in the following respects:
Distributed nature of data and applications
Forward deployment of logic systems and intelligence into reader physical environments
Virtualization of tagged items
Provision of local policy at point-of-read or place-of-storage of items
Use of Services instead of Protocols

Ellipsis uses a proximity model to place virtual intelligence physically near the tagged items. Being nearby and also being associated with the RFID tags, this intelligence provides rapid application of business intelligence to the local treatment of the tagged items. In addition, the local agent is transaction ally linked through remote communications with globally persistent storage and ‘bigger-picture’ applications.

For each RFID class, vendor, and serial number, a virtual software agent is created with mobility properties so that the business intelligence and data history of a tagged item can travel with the item. Functionally, this mobile agent must travel within a larger distributed software system. It needs a compatible and nurturing software environment in which to deploy. It needs physical computer systems to deploy into.

### Ellipsis and the Service Grid

The Service Grid is a middleware platform on which specific distributed business applications can be built and managed. Ellipsis is just such a specific business application, built using the Service Grid, delivered with it, and managed by it.

See FIG. 24: The Service Grid is a Collection of Services Deployed on a Network of Distributed Computers

The Service Grid will exist on a code server, directory and set of distributed containers, and Ellipsis is a specific set of agents designed to handle RFID-specific tasks. These agents will be deployed into the network, coordinated and managed by the service grid utilities. By existing within the Service Grid service community, Ellipsis features the absolute reliability that comes with the survivable grid.

The Service Grid is a blend of Component Architecture and Service Oriented Architectures (SOA). Participating in the Service Grid, the services developed for Ellipsis can draw upon a wide variety of communication and business support components. These ‘macro-services’ include system management applications, security, accounting, messaging and notifications, policy, work collaboration, distributed data services and widespread external software connectors. These components collectively provide templates and building blocks for specific business tasks and goals.

Further, the Ellipsis service characteristics (from SOA) inherit a wide variety of significant behavior from the Service Grid Microservice super class root service. This behavior includes mobility, remote deployment, integrated management, inter-service reliable communication, and extensive security. The basis for these features is itself our Microservice model.

### Microservice

A Microservice is a small unit of software that acts as a single-function component. It is the smallest reusable building block from which business applications are assembled. Microservices deploy remotely and discover the other services needed to perform more complex functions. Thus a Service Grid application is built from an interacting community of Microservices—which also call upon one or more of the major middleware components.

Technically, a Microservice is a small, re-locatable agent-service that acts as a resource for other services. Generally a Microservice supports one functional business interface and any required administrative interfaces. The Microservice fuses a Jini Enterprise service with a modification of the mobile agent software template. The significant modification to this template is the removal of any internal itinerary: in effect, the removal of self generated mobility and the replacement of this with 3^{rd} party authentication and deployment control. Service Grid Microservice agents rely on the external management system to relocate an agent into new containers. This overcomes the most significant security concern about mobile agents. Another historic concern about mobile agents was the cost and effort of monitoring software that could show up on any system; Service Grid overcomes this with an extensive self-management service structure and strong management components. Together these innovations make mobile agents acceptable to mainstream applications and unlock their value.

See FIG. 25: Derivation Technologies as Utilized in a Microservice & Support Systems

Microservices are deployed by external Life-cycle Managers into Service Grid Containers. The container is an enhancement of a Virtual Machine model that makes the Container a Jini service discoverable by other services, and the container environment for mobile agents which provides a location for agents to unpack and execute. Life-cycle Managers insure that the correct number of containers and the proper mix of service and component resources are always available. Management agents watch individual services restarting these under local failure conditions. Life-cycle managers are now well understood in distributed computing. What is novel with the Service Grid invention, is the adaptation of management agents as 3^{rd} party controllers for mobile agents.

See FIG. 26: Microservice with Service Grid Support Services

### Service Grid Architecture

The Service Grid includes a large group of utility services that provide for the needs of future IT organizations and their enterprise clients. This service grid is inherently extendable; as more business niches open up, services are developed to fill them. As more services are developed and deployed, the more complex and richer the system gets. Paradoxically, via the now established principles of complexity and emergent behavior, the richer and more complex the system becomes, the more stable it is in the face of errors, environmental changes and deliberate disruptions.

The individual software elements of this system are small services. These are java services with reflexive interfaces. They are sometimes enterprise Jini services able to register globally and globally find and invoke other services. Other times they are javaspace clients. These services include non-autonomous distributed “mobile” agents capable of being remotely deployed into generalized containers. Mostly these services are quite small: only a few hundred lines of business code coupled with an extensive set of inherited features. The agent services interact with other resource services to form applications. The invention refers to these mini-component services as Microservice.

Microservice: Any service that inherits the characteristics required to deploy in the Service Grid and built into the system for business goals (example: implements remote management interface). These follow a mobile agent pattern, but non-autonomous, without any itinerary subsection—that is, these are safe mobile agents without self-mobility. A pull model is used by Containers and by life-cycle agents to remotely deploy these services into Containers.

See FIG. 27: Inheritance of Major Types of Microservice

Service Grid: The entire distributed system of interacting mobile services that provide distributed application development and functional deployment including the software, the physical infrastructure and the network.

Infrastructure: The physical grid. The distributed hosts (servers) and the network (VPN) over which communication between hosts occurs—the hosts support containers which support Microservice services; the network contains switches, routers, fiber, wires, circuits, routes, tunnels, and internet middleware.

### Service Grid Infrastructure Services

It is important to describe some of the main common services that derive from well known Component architectures are deployed in the Service Grid, in order to understand how these interact with the specific services developed for Ellipsis.

Registry: The repository of system-wide internal configuration data—configuration information is stored away from the hosts doing application processing. Configuration information includes all the server hosts, their IP address, and Kerberos security access. It also includes all the containers and services that will be maintained as durable services. With the services are the initialization data that they require. The Registry is an LDAP directory with configuration information in XML format.

Code Servers: Code Servers contain binaries for services that run in the grid. This is maintained in JAR files. The Code Server is implemented as an HTTP server (Apache open source). Services are remote loaded from these containers by reference to the URL of the JAR file. Several Code Servers will be present in the grid at any one time. Code services originate with the concept of Applets and more specifically Servlets.

Containers: Containers are the major service, the cradle, in which all the Microservice run. These Containers are enhanced JVMs (Java Virtual Machines) which themselves are Jini services (or are .NET container service machines). They provide the local processing environment for the Microservice agents. Many services can run in a container; many containers can run on a host. All Microservices services reside in Containers when deployed.

Spaces: Neither the Tuple-space nor the enhancement of it called the JavaSpace is unique to this Service Grid. This exemplary implementation uses JavaSpace implementations from both Sun Microsystems (Outrigger) and InterMission (Autevo). Other tuple spaces can be uses which function just as well. For instance, a deployment of an original tuple-space with JavaSpace-like interfaces and properties, using Microsoft .NET technology.

Utility services: Microservice that exists to provide resources to other Microservices—utility services are tools that provide for business goals of code reuse and rapid development. Much of the structure of inter-service communication and interactions is embodied in utility services always present as durable services. For instance the Grid Service Router.

Bootstrap Service: Allows an administrator to remote load a UI and invoke widespread service deployment based on Registry templates. Includes heavy-lifting deployment of JVMs, containers and other OS services.

Lookup Service: Used by services to register and find each other in real-time. Inherits from Java Jini parent object code. Is augmented with enterprise wide discovery functionality. Contains proxy code for registered services, which can be downloaded into requestor services.

Survivability services: Microservice that provide for lifecycle management of other services—several management agent patterns exist which will detect a failed service and restart that service—often in a different container. The Smart Reconnection Proxy that is inherited by all Microservice also enables survivability, as does the mobility provided by remote loading into containers.

Life Cycle Manager: Service which can read from Registrar and deploy other services. Also can interact with Lookup services to insure recovery of any registered service which fails.

Life Cycle Agent: Can be paired with one-or-more services. Insures service is restarted in service fails. What is novel is the ability of these to enforce policy on services.

### Components

Components provide broad business services via a simple, easy to understand interface. In actually, Components are implemented via large quantity of interacting Microservices, grouped as a community via life-cycle managers. In order to retain the traditional strength of Component Architectures: Well known and stable interfaces, the Service Grid uses the Façade design pattern where one Microservice implements the Component Interface and fronts for the community of services providing the composite functionality. Thus we get the best of both worlds: Stability and Adaptability.

See FIG. 28: A Single Microservice Will Implement the Component Interface, Fronting for the Component community

Security services: Microservice that protects the system against unwanted intrusion, discovery of information, or software attacks. Complex webs of specific utility services utilize inherited characteristics bound into all Microservices. Some facilities are realized via external product such as the Jini version 2 secure RMI specification, multi-path certification, and Kerberos control of telnet agents. Some facility derives from structural characteristics of the Service Grid such as the fragmentation allowed by Microservices; the non-residency of code on servers and the difficulty in external discovery provided is the mobility of these services.

External Connectors: Recognizing that communication with applications other than native Microservice is important in Enterprise applications, the Service Grid provides basic services that communicate and graft on to external products. Most of these are based on well-known standard interfaces. Sometimes this interaction with heritage applications is accomplished via specialized Smart Proxies that invoke translation and policy services.

Behavior Service: A collection of services that enable connection to an external Rules Engine. This Rule Engine can incorporate user defined policy statements into the general behavior of other services.

Messaging service—JMS Interface: A Connector service that supports the industry-standard Java Messaging Service, publish & subscribe notification interface, is provided. This interface amalgamates Jini notification services with the standard interface supported by most Pub/Sub products. This allows interaction with the messages most often sent in the EJB and EAI product worlds.

Distributed Data Grid (DDD): A major subsystem comprising a grouped complex of enabling utility services that provide storage and retrieval from multitudinous Javaspaces and databases distributed over global distances. A service can find and interact with business objects without any knowledge of where the data is or how it is stored and formatted. Javaspaces act as short-term memory or caches and databases act as long-term memory providing persistent storage and data replication.

Transaction Service: Extension to the semantics of the Jini voting & token passing transaction service to interface with 3rd party applications that support the XA distributed transactions service. This allows ACID transactions across databases in multiple locations from multiple database vendors. Transaction services are a well known, powerful inter-service programming model. What is novel use in this Service Grid is the incorporation of several different rich transaction templates together: including tree-nested structures, fuzzy transactions following decision pathways, state machine driven transactions, and short-or-long time bounded transactions.

Javaspace: Depending on the specific need, Assurance deploys with, and supports interaction with, Javaspaces from multiple vendors. Javaspaces provide for asynchronous and loosely coupled interaction among services that implement the Javaspace API. Javaspaces are found as data cache in the DDD, as data selection systems in the Collaborative Work Manager, and as inter agent communications systems in the HIJAS.

See FIG. 29: Prior Art—Tuple-Space Implemented as Javaspace

Collaborative Work Management: A major subsystem comprising a complex of services that re-invent the traditional management console, work flow, process management, trouble ticket and help desk products. Automation provides for packaging of information into a common, shared environment/virtual space into which users are invited, there to interact at reaching a common business end.

Aggregators: A collector-service that instantiates grouping-buckets for sorting real-time streams of information. These buckets are living services that are generally controlled by adaptive state machine technology. This allows the bucket to evolve based on the events received—including varying of the information collected and the actions taken by the living service. Aggregators are 1000's of times faster at sorting information streams than the typical ‘store to database and report’ programming method.

Avatars: A service that represents a person or physical thing as a software service—This allows people and physical things to interact with Microservice just like they were another service. With an Avatar, a person or thing can participate in automation. The Avatar understands how to communicate with the artifact or how to reach the person. When a person is logged into the network, they are in constant communication with their Avatar, which acts a surrogate for the individual to the Microservice.

Human Avatar: A service that represents a person as a software service—This allows people to interact with Microservice just like they were another service. With an Avatar, a person can participate in automation. Novel here is the programming of an avatar based on the mobile agent template.

Human Avatars are well known. What is novel use in this Service Grid is the extension of the Avatar model to represent any ‘thing’ as a software agent.

Device Avatar: A service that represents a network device as a software service—This allows physical things to interact with Microservice just like they were another service. With an Avatar, a device can participate in automation. The Device Avatar links to the physical devices and reflects device status as service state information.

Host Avatar: A service that represents a server as a software service—This allows servers to interact with Microservice just like they were another service. With an Avatar, a server can participate in automation. The Server Avatar links to the physical server and reflects server status as service state information.

Group-space: A specialized fusion of aggregator, javaspace, and peer-to-peer groupware technology allowing aggregation and interaction of people (via avatars and UIs), data and software tools—Each group-space is deployed by a service factory to track and manage the lifecycle of a specific problem or business task. In the group-space, users are invited to interact as a team in the accomplishment of a specific goal with equal access to the same information and tools. The concept of a Group-space is well known; what is novel here is the use of a javaspace as a implementation template for a group-space.

Work Groups: Collections of users interacting via their User Avatars.

Policy Agent: A service that includes rules for controlling the real-time behavior of other services and objects. These are programmed in as Event, Condition, and Action (ECA) statements.

Group-spaceUI: The console by which a user can track and interact with all the group-spaces with which they are interacting—generally a swing application, a user can request notification for any even and monitor the progress and priorities of all their tasks.

The architecture of these main components and services is not novel to this invention. They occur in many deployed systems and products today and are being adopted in standards communities. The exemplary implementation derives most of these components from the TeleManagement Forum New Generations Operating Systems (NGOSS) and from the Object Management Group (OMG). Other services are well known to the Jini Community. The novelty of this Service Grid comes in the implementation of these component services via Microservices and in the strong security model applied to the Service Grid via container modifications, security agent services, and deployment techniques.

This specification will not describe individual use cases of interaction among these services. The variations are legion since as basic resources, they interact in most all business processes. What is novel with this Service Grid is that these services use, and layer, a rich collection of interaction patterns from modern distributed programming. These include:
Event response
Service transaction voting
Tuple space master-worker
Nested transactions
State machine control
Clone and return
Agent swarming

### Architecture of the Grid

The mobile agent model is a pairing of code between a Microservice and a Container.

Container:
An OS service that provides an environment for remote deployment of Microservices
Allows services to execute
Enforces security
Enhanced from a Java Virtual Machine (JVM) or .NET remoting service)
Many services may reside in a container
Containers come in several specialized forms (open, secure, accounting enforcers, & external agent hosts)
Containers can be nested in containers.

Virtual Infrastructure:
Assurance services will interact from inside containers.
Services can interact with other services in other containers.
Domain local and remote domain interactions are supported.

The grid system contains many Domains. Each Domain:
Provides both a logical grouping of services and physical grouping of server hosts.
Provides a network (Bridged LAN) demarcation of multicast service deployment.
Multiple logical domains can exist in a physical domain.

A Domain always contains: Exactly one Life Cycle manager. It must contain at least one Lookup service. It will contain many service containers.

Physical Infrastructure: The Service Grid will implement on a physically distributed network of many servers. These servers interconnect with a Virtual Private network (VPN).

Host Servers: Because multiprocessing interaction occurs at the application layer over a network, small servers work as well as large multiprocessor servers; yet smaller servers are more cost effective; provided the network is of sufficient quality.

Carrier Network: Domains are linked via a VPN. Enterprise or Carrier network equipment supplies the physical and logical communication. Globally distributed networks are supported. Multicasting is generally not supported outside of domains, between domains.

### Use of Services Instead of Protocols

The Service Grid uses services, specifically mobile services, instead of protocols. This allows for general and specific solutions that are easily changeable and can scale better. ‘Services substituting for protocols’ was introduced via Java and Jini. Mobility is added with the Microservice model.

These services can exchange the mechanisms for remote communications including protocols and remote method calls. Coupled with the refreshment of service instances allowed by the remote deployment model of the service grid, this allows communication protocols to be changed as needed. This is important when services are separated by unique data communications circumstances such as wireless, low-bandwidth transmissions. It also allows web service protocols to be dynamically substituted for RMI protocols when the services must communicated through non-permeable firewalls.

Generally protocols take a lot of effort, cost and time to establish. Often this process extends over years. Once adopted by a large number of participants, protocols tend to become ‘frozen’ since the coordination problem of all users changing is quite significant. Use of intercommunicating services allows for upgrades and changes as fast as advances technically occurs.

Ellipses Service Grid services adhere to a complex of features that make the service-to-service communication quite reliable—these include basic survivable system templates such as the smart-reconnection proxy and the failover to new service instance discovery.

Other significant, novel reasons exist for service-to-service communications. These include security enhancements and morphing of service protocols due to environmental, regulatory, or security policy.

### Basic Microservice Model from Agents

An agent is a software application that has a specific task or business goal delegated to it—that is the reason for the agent's existence. Sometimes agents act in behalf of people, accepting the delegation of tasks, but other times these are delegated by the system or software designer to perform other business goals. Agents need a specific nurturing environment in which to run. Generally this is called a ‘container’ or a host.

Agents usually exhibit certain properties. They are reactive to changes in their environment. Often this means they can receive messages and then act on these messages. Agents are usually continuously operative during their life. Meaning once created, they stay alive waiting for messages or querying their environment for data; until they are killed. An agent is goal driven. An agent is autonomous in the aspect that its code is self-contained—it may communicate with other agents, but it does not call them like subroutines. (A java bean is not an agent).

Sometimes agents are designed to be mobile. In these cases the environment of the agent must support this mobility. Basically this means that the place the agent moves to must have the same resources to sustain the agent as its starting location. Today, two language groups provide for code mobility that greatly simplifies the creation of mobile agents. These are Java and C#/.NET.

### Distributed Agents

It is more accurate to call Service Grid a distributed agent system than a mobile agent system. But as I explain below, part of the novelty is that it performs like a mobile agent system.

Earlier architectures for autonomous mobile agent technology failed to find traction in the marketplace. I believe this is because of three crippling features. First was the ability of mobile agents to clone themselves by copying their code and data from one system to another. While this provided strong benefits in designing and deploying applications; this model was essentially too much like a computer virus. Strong issues of trust were invoked that blocked the distribution of agents. Second was the autonomous nature of these agents. As they moved about, they presented a system management problem that was often of the same effort magnitude as the business problem they were designed to solve. This negated the efficiency of these approaches. I still believe the mobile agent model to be of profound advantage in providing efficiency in application design if significantly altered to correct and overcome these prior deficiencies.

Service Grid removes the ability of the agent to directly clone itself. Instead Service Grid uses a third-party actor to coordinate ‘movement’ of agents. This third party actor, a service we adapt & enhance from traditional life-cycle services, controls the creation and destruction of agents in the ecosystem. This system allows for strong security models to control agent deployment and existence. Additionally it, like many java-based agent systems, uses basic java language features to pull agent code from code servers instead of push agent code from the agent itself.

So all Service Grid services are distributed services that are controlled and launched by a 3rd party service. For other systems, services are ‘just plain agent services designed to a fixed job at a fixed location during their instantiated life’; however, Service Grid supports a type of virtual mobility for agents. The code base that needs to be exchanged is ‘brokered’ through a 3rd party. Sometimes this is an enhanced ‘lookup service’ such as is derived from the Jini model. Other times it is a gateway service between domains. Or it is just a simple agent ‘cloning service’ that can natively copy code base, data and state. What happens in all of these approaches is a ‘copy’ of the agent can move from server to server; even though the agent never directly copies itself.

See FIG. 30: Microservice with Service Grid Support Services

The second main problem with agent systems, system management, Service Grid addresses via placing a management interface into every agent. This management interface is used to identify the agent, where it is, and what is state is. The interface allows life-cycle services and management agents to invoke communication with any and every agent in the ecosystem. Service Grid supports both active-push messages and connections by the agent into the management services. It also supports a responsive management model where the agent responds to requests by returning information about itself or invoking internal actions (such as persist or die).

Lastly, mobile agents failed to gain acceptance because of lack of a common container environment, which would let agents written by one programmer, run in containers written by another. The Service Grid uses standard VM contains modified to function in a grid thus providing a model where standard containers can be deployed easily and provide a common environment for agent services. These containers are generally enhanced with security features so they can participate in 3^{rd} party authentication before accepting an agent.

### Microservice Detail

A Microservice is a small unit of software that acts as a single function component. It is the smallest reusable building block from which business applications are assembled. Microservices deploy remotely and discover the other services needed to perform more complex functions. Thus a Service Grid application is built from an interacting community of Microservices—which also call upon one or more of the major middleware components. Because it is small and single function, it enhances the success rates for programmer creation with Rapid Application Development methods.

Technically, a Microservice is a small, re-locatable service that acts as a resource for other services. Generally a Microservice supports one functional business interface and any required administrative interfaces, these usually through inheritance. All Microservices inherit from a common superclass.

Internal features of every Microservice include:
XRI naming
Code facilitating deployment into a container
Code facilitating self registration
Code for finding other needed resource services
Smart reconnect proxy for remote service communication
Generic service interface
Generic security interface
Generic accounting interface
Generic management interface
Every Microservice inherits the ability to externally express internal data as XML data.
Standard management information (API and XML)
Extensible management information as XML

### Service Grid and Survivability

Service Grid provides an efficient N×N redundant, high availability platform for a fraction of the cost of current replication of data and applications to a standby disaster recovery center. This is a by-product of the self-managing, self-healing design of Service Grid mobile Microservices and watcher life-cycle managers. Survivable applications are now well understood by several advanced practitioners of distributed systems. Standard methods provide for stepwise recovery from a resource failure: monitoring of the health of a service, discovering the service is missing, re-launching the service from a code server, re-loading the data and state information of the service from the management agents, and then registering the service in the look up service, where after all the community of user services find it and re-link, thereby continuing the operation of the system large. We refer to this as survivability through the regeneration of services. It does not matter if the systemic failure is in the application, the operating system, the computer or the network; Service Grid's response is essentially the same.

See FIG. 31: Microservices Find and Link with Other Microservices to Form a Community

A Microservice provides application value by finding and connecting to a series of other Microservices in what we call an application community. Every service is watched by one of several types of Service Grid agent service. When the life-cycle agent detects a failure of the RFID agent it is monitoring, it launches a process where a fresh software copy of the service is remotely loaded from a code-server into a healthy container. This container may be on a different computer or a different network segment. This new RFID agent clone, and the other Microservices in its community, then find each other, reconnect and begin processing as before.

See FIG. 32: Regenerating a Tuple-Space Upon Failure, Thereby Providing Survivability

This same process, coupled with Service Grid's storage of system and service configuration information in an external directory, allows for rapid, automatic deployment of Service Grid systems. In this case, secured computers are pre-deployed and networked into the larger Service Grid VPN. The root Life-cycle agent reads the configuration directory to discover the address and secure logons to these computers. It then logs in and brings up basic java services and the Service Grid containers—a bootstrapping process. Management agents then begin spawning life-cycle agents for each domain in the system and these agents in tern spawn their own child life-cycle agents. The code for these is remotely loaded, over the VPN, from code-servers directly into the waiting containers. Each life-cycle agent reads the directory for configuration information on its subject domain and then loads all the required service resources. These Microservices then find each other, establish connections and begin processing. With this technology, one command can bring up every application service in the customers system: effectively thousands of applications on potentially hundreds of computers. Once established, no local effort can shut down these services.

See FIG. 33: Remote Deployment of a Tuple-Space and Associated Client Services

### Solving Fragmented and Huge Data Problems with the Service Grid Platform

The potentially massive data throughput and accumulated data volume generated by RFID tag-reads throughout the supply chain pose a major problem for any application, particularly any written on n-tier client-server architectures. Current practice before Ellipsis is to fragment unchanging data into lots of isolated PML data servers linked by protocol requests and to fragment session data (location, time, state) into closed, external applications owned and controlled by local members of the supply chain. Gathering information from all these sources becomes a major task of many parallel queries, many comparisons, resolution of discrepancies (a major task), and the final ‘mung’-ing and integration.

Ellipsis' Data Grid and global service architectures was designed to solve these very problems. Ellipsis will employ these to maintain a higher-level distributed coordination of data, while maintaining a virtual distribution of specialized PML servers for standards compliance. Where the PML services already exist outside of Ellipsis' control, Ellipsis services will attach to existing PML servers, organizational data registers and heritage supply chain data repositories via a class of specialized Microservices which implement the specific translations for a proxy adaptation interface.

Local information needs for real time response will be met by the data contained in each Microservice virtualization of the RFID tagged item. These data units are already organized and synchronized by the system and will provide most real-time and near-real-time data needs.

Essentially, Service Grid includes a stage two, data grid, as one of its components. This allows many databases to be incorporated as a single virtual service that any Microservice can access (for instance Oracle 10g). The Microservice does not need to know anything about the location and structure of the data is seeks. Service Grid arbitrates the access to data, the delivery of local data to the point it is needed, the synchronization of that data with persistent storage, and coordinates multi-database ACID transactions using the XA distributed transaction standard or the Javaspace transaction template and interface.

### Distributed Grid Infrastructure for RFID Middleware

See FIG. 34: Forward Deployment of Ellipsis into Supply-Chain

Making Service Grid mostly self-managing reduces the need for centralized system management; The Vendor enables large cost savings by enabling clients to use many smaller commodity computers. The Vendor uses wide scale dispersion and fragmentation of computing resources like servers as a way of protecting the system against local failures.

Initial industry grid deployments were applied to embarrassingly parallel, massively compute-bound problems. These stage one grids were about moving the processing “cycles” to computers with underutilized capacity—moving the computing to available resources. Later, with the development of distributed transaction capacity and large local data repositories, stage two grids, so called data grids, evolved to move the processing near the data stores. Service Grid is a stage three grid. Service Grids are about moving the computing and the data to the areas where business process are occurring. The Service Grid is making computing more congruent with the real world and less driven by the historical trend of centralized IT resources.

This approach changes the way we think about supply-chain systems; instead of imagining large, centralized B2B systems or SCM systems, our solution uses many Microservices dispersed in a grid of servers. The physical grid of servers is dispersed into many smaller data centers, into remote managed ‘dark closets’, and into the physical action areas of the value and supply chains. This includes servers located in factories, transport hubs, warehouses and retail centers. Generally NEBS compliant servers are used for absolute mission assurance, but any computer capable of hosting a Java virtual machine (JVM) or running Microsoft's .NET can be used.

A major advantage of this grid dispersion, coupled with the mobile nature of Service Grid Microservices, is the ability to move program execution both close to the data it uses and close to the consumers of the program output. With Service Grid, the data is communicated between cloned Microservices via components and intra-service communication.

### Distribution and the Supply Chain

The Supply Chain is a naturally distributed environment—in fact it is often called the distribution channel. Goods travel from point to point across geographic distances. There are diverse origins of these goods, transshipment and storage locations and many pooling points and fragmentation events in the life cycle of their economic usefulness. At each of these locations or transit channels, events can occur which have significance to the valuation and subsequent handling of these goods. An ideal system would capture not just the route taken by these goods, but all the events that occur during this movement in the value chain.

See FIG. 35: Supply-Chain is Naturally, Physically Distributed

I started product design with the basic requirement of tracking and capturing all these events as they occur and making this information available to downstream systems that are making business decisions on treatment of these goods.

Existing approaches attempt to fit a pre-existing image of what IT resource deployments should be or actually are, to the dispersed nature of the supply chain. These existing images are driven by Enterprise Resource Processing (ERP) which, given existing IT technology of the nineties, found centralized data centers the most cost effective IT deployment model. Therefore data capture programs (or agents) are placed at the physical nodes of the supply chain and a network must be used to transfer the data collected back to a centralized data center for processing. This approach results in:
Delays from network transmission
Subjects decisions and information to the unreliable nature of networks
Necessitates a central organization of data structures which may not be that of the local data capture points, requiring translations and re-segmentation of data
Favors centralized reporting as the tool for analysis and work flow as a means of reacting to data

However, studies and field trials have found that automation is best realized by event-driven systems that utilize policy to implement process, and not work-flow. Policy has also been effective in solving complex routing requirements in very large networks. Adapting centralized systems to react to events and to use policy and rules (event, condition, action statements) have proven problematical and expensive. Getting central decisions back to the localized sources, ironically, is itself an IT data distribution problem.

### Deployment Near Readers

Consistent with Service Grid's dispersion of large datacenters into a global grid, and the movement of computing power near to the producers of data and consumers of work actions, Ellipsis spreads the grid into the active areas of the supply chain. Ellipsis deploys data capture services, data communications services, work coordination services, and event policy-based response services in the same local environment that the tagged items are read. This allows local processing of data and rapid response to events. Remote transport of the data is lessened and bandwidth requirements reduced. But the most import gain is in the speed of data processing and data matching applied to policy for business goals. Control logic for the industrial environments can be directly realized by the local Service Grid deployment; alternatively, proxies can link to existing control systems. This could include integration with assembly line automation.

Places that will gain value from these local processing deployments include:
Resource producers
Factories
Packing centers
Transport hubs
Receiving areas
Warehouses & storage bins
Work and Pick list assembly points
Test and QA zones
Retail ‘smart’ shelving
Advertisement and promotional zones
Checkout centers

### Ellipsis RFID Agent

Utilizing the unique characteristics of the Service Grid, mobile software agents can relocate in close proximity to RFID tagged items. Once associated with the tag, these agents are pulled near to the read and provide local control, environmentally responsive policy, and permanent data capture & history.

The basic idea behind the RFID agent [also called the Ego-Avatar) is simple. Because of economics, RFID tags must be small, simple, and conservative of power—and at best, externally powered. This limits the data that can be contained on the tag and the ability to write fresh information to the tag. The Vendor's RFID agent is a virtual business object that is linked to the RFID tag via the specific identity code that is written to the tag. All the information that world be useful to have at hand, but cannot be stored on the tag, is written into the RFID agent.

Besides the manufacturing data (typically makeup, composition, lot numbers, delivery instructions) that is stored in the RFID agent, the agent can also store policy in the form of rules (event, condition, action statements). The agent subscribes to events and reacts according to the instructions in the rules whenever it receives a triggering event.

The RFID agent moves about in the supply chain following the tagged item. Whenever a read of the tagged item occurs, the RFID agent learns of this and locates into the closest free resource container in the Service Grid system. As the tagged item moves about in the supply chain, new data is added to the RFID agent so that it contains a complete history of the item.

See FIG. 36: The Internal Objects of an RFID Agent

All relevant information about a physical item, which will have an RFID tag attached, is stored as data in this mobile agent service. This includes, but is not limited to:
Type of item, family classification of item and uses
Serial number
Manufacturing lot numbers
Creation place and date
Composition
Assignment or ownership

This agent also contains event, condition, action (ECA) statements that embody policy for the item including but not limited to:
Liability polices
Environmental policies
Handling instructions
RMA treatment
Disposal instructions

The virtualization can contain links to service level agreements that cover the item.

As the item moves through its life cycle, more information is added to the virtualization agent. Some of this is data such as:
Location-time history
Environmental factors history
Damages and repairs
Ownership or responsible body transfers

Other information added can include new or changed policies.

Generally no data is ever deleted during the life-cycle of the item. But for practicality, some information can be removed from the virtualization agent service and substituted with a remote association linkage with an external service that contains a persistent record of the information.

See FIG. 37: The Agent Resides in a Container But Associates with a Tag and Links to a Tuple-Space

### Medical Data Card Analogy

The inventor has found that making an analogy from the medical records system and modernization efforts does a good job and educating readers as to the significance of Ellipsis virtualization of intelligence and history for RFID tagged items.

In the current world Medical data is hap-hazardously strewn about many independent, non-communicating data systems: in doctor offices, hospitals, home records, and insurances companies. Data on a specific individual is fragmented and nearly imposing to reconstruct in its entirety. There is no collected record of the medical history of just about everyone alive. Generally many different identification numbers identify most data: for example the social security number and the insurance medical ID of a specific health insurance company. Using this to link data is difficult but possible, if one can send enough queries, wait long enough and live with errors and omissions.

It has been proposed that all people carry a high storage capacity ‘smart card’ instead of medical insurance Id cards. In this card would be stored the critical identification and health characteristics (like blood type and allergens), doctor references, next of kin and even the complete history of the individual. This would greatly alleviate the problem of fragmented and missing health care information. It would provide perhaps lifesaving rapid response and specifically tailored medical responses during emergencies.

Ellipsis can be thought of as providing a virtualization, like the medical smart card, of an RFID tagged item smart card via a mobile software agent. Since economics dictate that current RFID tags cannot carry this information themselves, this is contained in a Microservice, a mobile data & policy-enabled agent that tracks the RFID tagged item around. Some data is maintained off board the virtualized agent, but the agent knows how to find this information at near-real-time processing speeds.

### Implementing Business Services

A specialized form of a Microservice is the Policy Agent. These generalized templates can be coded with a wide range of behaviors. Events or other interactions with the policy agent will invoke this behavior.

See FIG. 38: A Policy Agent is a Specialized Form of Microservice

The RFID-agent will be encoded with policy. Usually these are local ECA (Event, condition, Action) statements embedded via a policy object. ECA: when an event occurs, a condition is checked and if met, a specific action is initiated. Actions can be quite varied and range from simple to complex. A complex action could be a multiparty distributed transaction with alternative branches based on different transactional failures. Policy can also be represented as a reference to a remote Behavior service (aka Rules Engine) however this is not the case in the current exemplary implementation.
For example, an increase in temperature beyond approved safety parameters in a room will trigger both a local alarm and a remote alarm in headquarters, also impending movements of new items to that room will be diverted. In turn, other rooms and warehouses will be polled for current and projected future capacities so that workers on the ground can be informed immediately as to the best places to move all items stored in the high-temperature room. The transfer of items would be generated as a collaborative work effort and tracked and the RFID-agent links into the collaborative group-space.

### Software Internals of the RFID Agent

The RFID Agent is a specialized Service Grid Microservice derived from the generic Microservice template by software inheritance and then augmented with special new features. Each RFID agent is designed as a software virtualization of an item or class of items that will be tagged and tracked through the Supply chain and/or value chain. Formally, the RFID agent is a model of the actual physical item it virtualizes, at least in the aspects of the physical item that are important to the supply chain. This model is built of data structures that include:
Structural data which provides basic identity and classification for the item
Attributes for various current states the item could be in,
Historical data for past state values, past locations, and past actions performed or taken upon the agent/item,
Policy on how external services should act in the presence of the agent.
   See FIG. 39: the Agent Resides in a Container But Associates with a Tag and Links to a Tuple-Space

The Agent implements a number of different interfaces related to its own management and the job it must do, but also has interface links to a plurity of other RFID agents and associated services. These include the implementation of the JavaSpace interface (in the ego-agent), the linkage to distributed data persistence, and the linkage to user interfaces via ServiceUI utilities. The object that the RFID agent puts in the Javaspace, the entry, is called the ID-agent.

The JavaSpace interface is utilized to store specific item instance objects in the JavaSpace. The JavaSpace then provides an inter-service communication platform for the object (data, methods, policy) as it is acted upon by many specialized business services that also attach to the JavaSpace. The RFID agent subscribes to most state and data changes made in the instance objects placed within the JavaSpace; and brokers the persistence of these changes.

Basic characteristics of Microservices are also present. These include:
Mobility
A management interface
A smart reconnect proxy
Security
Accounting
XML data expressions
   See FIG. 40: Anatomy of the Movement of an RFID Agent from one HIJAS to Another

Each class or vendor of tagged items is represented in the Service Grid Global Grid as an Enterprise-level service. This Super RFID Agent (also Ego-Avatar) contains all the class/vendor specific information that will be shared by all tagged items of this vendor/class. This includes basic data (like a vendor's PML system would store in Auto-ID approaches) and basic structure and policy. It includes associated links to logging, security and accounting service identifiers at the vendor/class level. These do not include service location information, because this changes dynamically in the Service Grid system where services relocate among containers and computers as business needs and performance optimizations dictate. Location is always found dynamically, in real time, as connections to remote services are needed and established.

When a new item of a specific vendor or class is manufactured or otherwise originally becomes discovered by the Ellipsis system, a software service-agent Factory, controlled by the Super RFID-agent service, generates a new object to represent that specific real item, as a specific software object instance.

For very valuable or complex objects, or object groups, a service is generated as a ‘virtual world service’ that stays alive in the enterprise grid monitoring the life cycle and movement of that object. Examples of items like this are lower volume, higher value products such as cars, computers, pharmaceuticals; and also large item groupings such as perishable item pallets, and container-sized shipping units. These services reside in memory and establish real-time connections to many clones of themselves that act to physically track with the item or to represent the item in work structures or grouping relationships. These clones can act extremely fast to implement local policy or to find and recall a physically tagged item. These clones, when in a local reader environment will bind to a JavaSpace and put an object representation of their item in the JavaSpace. For grouping container items, like pallets, they will put an object in the JavaSpace for each item in the group.

Most inexpensive, high-volume tagged items will continue to be represented at the service level only by a grouping of Super RFID-agent services. For instance, this might represent the all members of a manufacturing lot, or all items of a type shipped to a specific customer location on a given time period. In this case all the individual item instances are represented as software objects in a JavaSpace. The objects move from JavaSpace to JavaSpace as needed and store permanent data specific to the individual item and policy for that specific item.

Every RFID agent and clone contains an integral management interface. These services will find and bind to a management agent to provide survivability of the agent services across network and platform failures. These interfaces also serve to allow users to inspect the services at will and to physically and virtually them. These management interfaces also work with Grid level performance monitors which may route services to specific containers as need arise.

### Ego-Avatar

Every device will have at least one instance of a remote Ego-Avatar service. The Ego-Avatar is a durable, living service that is always on and active during the useful life of the tagged item it models.

The Ego-Avatar represents a ‘complete’ picture of the device and includes:
Current inventory
Historical inventory
Current configuration parameter settings
Near real-time state information
Transactional controls for provisioning updates to the items policy and parameter settings
Persistent storage for the Ego-Avatar
Interface to the serviceUI's that present status graphics of the RFID tagged item
Policy statement parameters
Communication/notification agent remotely attached to the HIJAS of the agents management domain

An Ego-Avatar can have clones of itself deployed for various special purposes. One copy is always the master copy. The master copy has either created the copies and maintains sync services with them, or it can be ‘elected’ to this role by the other copies. Copies can be complete copies, or special remote agents with specific data subsets and behavior. Copies exist to, among other things:
Represent the device in complex interconnections and assemblies or transport groups
Provide for simulations
Provide for failsafe service backup standbys
Provide timely reaction and responses for very remote users and service interactions.

The Ego-Avatar is associated with, but external to any HIJAS. The Ego-Avatar service typically will deploy a remote child agent (ego-agent) into a HIJAS to enact a JavaSpace interface into its current RFID location management domain; this child agent service is called the Ego-agent. The Ego-Avatar, remains a remote service communicating with all is children clones.

### The Ego-Agent

The Ego-agent is a Microservice agent linked to a HIJAS subsystem (explained below). Yet the Ego-agent is also a child of the remote Ego-Avatar service. Lastly the Ego-agent is a mobile agent that effectively relocates from one HIJAS subsystem to another HIJAS subsystem at another location. Because of the special relationship of the Ego-agent to its parent Ego-Avatar, the Ego-agent is explained at this time, before the introduction of the HIJAS subsystem. (All are RFID agents).

The Ego-agent is created when the item initially becomes known to Ellipsis enabled system. Everywhere the item goes and everything that happens to it gets encoded in the Ego-agent and for persistence passed in a transaction to the Ego-Avatar. Its history becomes permanently attached to the item and is always locally available via an Ego-agent service. Complex information of almost unlimited scope can be maintained and acted on locally. The tagged item has a history, memory as well as identity.

The Ego-agent can be encrypted and secured. It can provide features such as non-repudiation to location reads and actions taken on the items behalf. For business, this means that as the item enters or leaves a new warehouse the read as the item enters the field of the reader at a certified location cannot be altered and can serve as a financial transaction. Grid services provide accounting between the agent and the container and between the container and master accounting services. These can take the form of milestones, budget credits, or micro-currency flows. The item has security as well as identity.

The Ego-agent will be encoded with policy. Therefore, the tagged item has flexibility as well as identity.

The Ego-agent does not live alone. It lives in a population of other ego-agents and related services. The ego-agent maintains external relationships that form a virtual model of the real-work physical groupings and logical associations. As tagged items are built into dynamic associations, a virtual representation of the physical system is created.
Such a physical association can be a pallet of crated RFID tagged boxes, or a shipping container of such. It can be a complex assembly like a machine made of separately tagged parts. It can be an assembly line.
   These associations are external to the ego-agent and maintained via relationship-stewards or javaspace connections. They can be made and broken in real time. Business actions can be made on the aggregate buddies as transactional semantics. So the tagged item is not alone, it is in a physical and business system.

### Tracking a Tagged Item Through the Supply Chain

These RFID-agents will follow a real tagged item throughout the supply chain. This is accomplished by placing Service Grid-enabled servers in all locations where readers exist, data needs to be captured, and/or policy needs to be enacted based on movement or condition of the tagged items. A typical deployment into a distribution center serving hundreds of trucks a day might be six inexpensive (workgroup-sized), remote-managed servers. Such a deployment could handle million of items with full survivability of the applications.

See FIG. 41: Agent Associates with Tagged Item Via Tag Id as Read by RFID Reader

Let us explore this agent tracking in more detail. When an item is shipped from one location to another, the local Ellipsis system will have a shipping order object. When the exit doorway reader or truck reader reads the items, the Super agent is notified in real time. The Super agent/Agent-Avatar then manufactures service item clones and puts these in every location on the shipping route the item is expected to appear. It also can put these clones in every location the item might possibly appear even if this is not usual, such as for historical shipping mistakes, transit options, and other low probability routing points. Whenever a reader reads the item tag, the location-probability targets of clones are recomputed, collapsing the location probability matrix and discarded useless clones.

Eventually the item ends ups at another Ellipsis local deployment and ‘rests’ there. All the shipping clones are killed off and the local Ellipsis system, via the software agent located there, assumes responsibility for the policy, state, and work actions on the tagged item.

### HIJAS: General Associated Services

The Heuristic, Intelligent JavaSpace Agent Subsystem (HIJAS) is a complete agent support infrastructure and agent intercommunication system that is remotely deployed and managed as a group. The HIJAS Manager Subsystem (HIJAS-MS) deploys and manages individual HIJAS. Each HIJAS provides a fertile zone where agents birth, work and die, while contributing to the assigned business tasks.

See FIG. 42: Architecture of a HIJAS Subsystem with its Manager and Service Grid

The HIJAS is a general-purpose software subsystem composed of many separate elements. The agents and support services that are deployed in the construct determine the behavior of the HIJAS. These participating services are identified by a template in the Registry and launched by a dedicated Life-cycle Manager.

Each area (RFID location management domain) where activities take place that effect RFID tagged items has a HIJAS system deployed with the associated Ellipsis Microservices. Depending on need, these subsystem deployments can be large or small. Functionally, the HIJAS could reside in a single server with multiple containers, but while economical, such a deployment would be unusual. For mission critical deployments, at least three generic servers would be pre-deployed at this location supporting the HIJAS agent subsystem. For high-volume, high-activity areas where tags are identified, such as large warehouses, the number of deployed servers would be larger to fit the workload. For absolute reliability, the servers are dispersed in the area, provisioned with a percentage of excess capacity for backing up failed or sabotaged servers.

These field deployments do not need dedicated System Administration staff. Typically, the servers are staged in a central location and all system level software is installed; because these are Grid clone servers, this system software is copied to all units. The computer equipment is shipped to the location and connected to the RFID readers, local and wide area networks. Once physically installed, all Service Grid and Ellipsis code is, forever afterwards, remotely deployed from code servers, totally hands free. This includes the initial loads, all updates, and all restorations. This is realized by remotely loading code, under the direction of a Life-cycle manager, from an HTTP server, to a container on the grid. The pattern of the deployed services, the grid of computers, and the parameters for services are remotely stored in the Service Grid Registrar component. Life-cycle managers and agents take this information and build complex service deployments automatically. Authorized system administrators, who can securely access it from any location on the network, put this deployment pattern information into the Registrar.

Any time a specific bit of logic or task is needed; a software factory manufactures the micro service instance that then launches to a local domain and connects to the JavaSpace. It communicates with the RFID-agent services indirectly via fetching and putting Entries in the JavaSpace, some of these Entries will be tagged item virtualizations, but others entry classes will be specific to the utility Microservice. Many kinds of tasks and logic are represented. Some look for specific events and invoke a response policy. Some look for patterns of multiple events and parameter settings and aggregate this information for lump transmission. Some of these services interact with secondary entries placed by other services or with outputs of policy responses. Quite complex behavior can be built up bit-by-bit following the generalized principles of Emergence and Synchrony.

Ellipsis uses HIJAS services to provide many additional technical advantages.
Actions can be non-interfering. For example, several services can subscribe for the same event and take many different responses to it.
Adaptation to change via remote loading of new code and also via specialized services of specific vendor JavaSpaces such as IntaMission's Autevo, which can support multiple interface definitions for a single service class.
Services can be redeployed to the closest server to tagged item as item moves from reader field to reader field
Able to scale—rapidly. Factories building more service instances.
Event storms are handled by additional consumer services being generated and even through additional space instances.
Subsystem synchronizations
Grouping information for bulk distribution
Grouping by intelligent patterns to allow complex responses.

Microservice agent types typically deployed in a HIJAS include:
Adapter
Aggregator
Policy Agent
Translator Agent for non EID tags
Remote Notification Agent
Entry Replication Agent
Entry Find and Fetch Agent
Persistence Agents (by Business Object class)
Logging Agent
Automation/Reaction agent
RFID-agent
Enterprise RFID super-agent proxy connectors
Grouping proxy connectors
Auto-id mimic services

Often many instances of these services are found at any specific time in a HIJAS subsystem.

Besides the local Microservices, the HIJAS and individual agents and services can interconnect with the larger Service Grid. In this way any enterprise service or component service can be accessed, on demand, in real time.

### HIJAS Manager Subsystem

HIJAS Manager Subsystem provides utility services for local Ellipsis deployments and for interfaces of Gateways with foreign, heritage applications. HIJAS Manager Subsystem provides the life cycle management of an entire agent system. This includes:
Remote launching HIJAS
Remote launching JavaSpaces or other tuple-space
Registration
Agent Factories
Group integrity and survivability
Remote Notification interfaces (JMS)
Cloning and synchronization
State and data replication services
Group Watcher
   See FIG. 43: Architecture of a HIJAS Subsystem with its Manager and Service Grid

Adapter (for RFID and barcode readers): The Adaptor communicates between the space and the RFID readers. One adaptor exists per reader. The adaptor understands reader specific commands and data. The adaptor understands timing, sequence and other parameters delineating special behaviors that are needed for successful completion of tagged item queries. The adaptor is capable of 2-phase commit transactional logic when supported by readers. And supports security features available with the reader. The adaptor can participate in non-repudiation conversations with the reader if the reader supports this. When the reader does not, it logs the reader data as the anchor point for all downstream non-repudiation. Where the reader allows bulk information transfer, the Adaptor captures this information. Many connection methods and protocols are possible. The preferred method is that defined by the Auto-id center. Otherwise generic XML dialects are easily supported.

Aggregator: Aggregators group information placed in the space according to complex patterns described in adaptive state machines. Grouped information can be returned to the space or sent to collection points.

Policy Agent: Invoke policy upon items placed in the space.

Translator Agent: Translates reader specific information to generic standard information (EID & PML). Translates generic commands to reader specific commands. Uses the Master/Worker template to fetch and deliver information to the space. In some instances, a channel pipe is used where sequencing between entries is important. Typical translations follow a generic to specific dotted format. Other associative translations are also possible.

Remote Notification Agent: Passes specific information in entries in the space to other remote systems; generally works in real-time and sometimes via JMS middleware.

Entry Replication Agent: Replicates entries to other JavaSpaces under control of the HIJAS-MS management. Receives replicates of entries from other JavaSpaces. Therefore provides agent-to-agent communication aimed at providing federated or cloned JavaSpaces.

Entry Find and Fetch Agent: This service can find entries in other JavaSpaces and duplicate them in the local JavaSpace. It can also just return a URL for the remote JavaSpace.

Persistence Agents (by Business Object class): Invokes Distributed Data transactional storage of important data placed in the space. On request fetches information from the Data Grid and places copies of this as entries in the space.

Logging Agent: Provides a sequential copy of space entries and actions to a file storage system. Generally stores in binary or XML formats. Can encrypt and provide non repudiation anchor service.

Automation/Reaction agent: Subscribes to specific entries and then invokes conditions. Upon match of conditions invokes immediate actions. Generally used to enforce parameter settings and constraints on configuration of device. Also provides automation by maintaining or returning devices to specific states or parameter settings.

These individual services are not themselves novel, but the collection of these services via javaspace communications services to provide business automation is novel.

### User Interfaces

Interaction of services with users is indirect. The service finds a serviceUI and attaches to it. The service UI downloads the user interface templates for that service.

A user always connects to a serviceUI that downloads to the user the visual format appropriate for the appliance the user is connecting with. This way a service always has the same data and interface methods. The serviceUI can send one applet type down for a console workstation and another for a PDA, another for a phone; it alone ‘understands’ the different interfaces needed by the user & appliance. This is the standard way Jini does user interfaces.

For user consoles, the swing java system for writing interfaces is generally used. Most of the interfaces look a lot like File Explorer or Outlook. Basically, a multi-frame window: an outline bar on the left and upper and lower windows on the right. What is in the windows is determined by what is selected in the outline. Often the right side frames have tabs that shift window content.

In addition, all services have a graphic icon loaded into their proxy code. This can be downloaded by services that can then display the icon. This is used in the Watcher to picture services running. The icon is active with methods attached; often methods that invoke other serviceUI interfaces. This can be extended to remote load any graphics directly from the service. All this is standard practice.

### User Interface with RFID-Agent

The RFID-agent can enact the major service interfaces to the ServiceUI which represent the tagged item and its associated display functions.

The RFID tagged item Console Interface is, for simplicity, described as a swing frame; other visualizations will exist for other user devices such as PDAs and Phones. The general class, vendor, make and instance of the RFID tagged item are represented in outline format on the left. Specific view versions can also group by location and location management domain as well. Tabs switch between outline grouping views. Selecting the RFID tagged item will bring up generic information in the upper right window. Selectable tabs separate different classes of information. The lower right window is slaved to the upper window (tab) are represents RFID tagged item specific information.

RFID tagged item Consoles can be in display only or in update mode.

Changes are always checked against policy and stored constraints and flagged in real-time if conflicts are discovered.

Actions can be taken against individual RFID tagged items, classes of RFID tagged items, or any other grouping reflected in the outline format. When action is invoked against a grouping, all members are affected. Choice of “all or nothing transaction changes” exist with constraints such as partial changes to group or time limits to confirm changes.

In addition various wizards exist that lead a user through grouping of related (and often transactional) actions.

Consoles can be invoked from inside a Collaborative group-space and display to all users with authorization who are subscribed to the group attached to the group-space.

### Location Management Domain Console

Besides looking at the tagged items as classes and individuals, users can also visually examine the specific locations where tagged items accumulate and are read. In this case a ServiceUI is provided to the HIJAS-MS manager and the specific HIJAS deployment. The user can examine all items in the location domain. In addition, a systems status console allows the state of the deployed agents in the HIJAS to be examined.

All the facilities of the Item console are also available in the Location console.

### Security in the Service Grid and Ellipsis

Security is maintained through several discrete methods that include separate encryption systems and structural elements derived from the architecture of the Service Grid.

Lower level, or ‘heavy-lifting’ security is resident on servers that participate in the system. Kerberos agents are loaded into servers that will participate in the distributed system. These Kerberos agents control telnet authentication of the Service Grid Bootstrap services. Once security is passed, the bootstrap service can bring up java VMs, Jini services and Service Grid containers.

Higher level, or dynamic security occurs inside Service Grid. Here, PKI and built-in proprietary service security measures are used. The Container supports service authentication. Services are authenticated against the container in which they will run. A service launch requester must be authenticated as a client of a Life cycle or management agent service. The requestor's authorization to use the container is checked. The container authenticates the code server address passed from the managing agent.

If the service is not authenticated against a domain (life-cycle manager) and specific containers, it cannot deploy—the container will not accept it or grant it basic resources. Security alarms are propagated. If a service authenticates, but security policy does not allow deployment within a container or at a specific time, the service cannot deploy.

With Ellipsis, when a shipment of widgets enters the warehouse, a software agent, which virtualizes that widget, is launched into the local IT system. Both real security, and perceived security, becomes very important. Users of the Ellipsis system must understand that their own Ellipsis life-cycle managers authenticate the foreign code before it can be launched. This authentication is similar too, but more automated and more rigorous, than the authentication of remote applications loading into a PC.

By setting security policy in Service Grid's Event, Condition, Action (ECA) security policy agents, or by accessing policy via remote behavior service connections, a user can control the deployment of foreign agents into their system. Foreign agents can be limited to specific Service Grid domains, servers and/or containers. Their access to remote Service Grid services can be constrained. Any time a service would seek to relocate, security policy would again be checked.

The Agent-Id entries inside a JavaSpace can be further secured if the user wishes. In this case, a local RFID-agent clone would proxy for the foreign RFID agents. Therefore a local service is generating all the JavaSpace entries.

### Security Model

Extraordinary steps are used to insure the security of application grids built with its technology:
Inter-server communication occurs over private or encrypted VPNs
Using policy-enabled switches, applications can provision their-own QoS requirements
Servers are remote manageable, small, field replaceable units
Operating systems are DISA certified: Secure Linux or Secure Solaris
Local access is not allowed to server OS, only remote management coordinated with factory-installed Kerberos agents
Applications run in secure sandboxes—virtual machines isolate applications from OS control
Only known services and our containers are allowed to run on these servers
Application binary-code is not stored on processing servers, instead it is remotely loaded at runtime from secure code-servers—stealing a server does not give access to application code
Applications are self assembling from Microservices running on many separated machines—no server ever has a full picture of what is happening
Security and policy domains are built in with brokered inter-domain communication controlled by security-policy gateways
Servers and domains are automatically isolated on intrusion detection and turned into playpens—real applications are automatically relocated to healthy resources, self assemble and continue processing
Honey pots can be dynamically deployed and automatically trigger domain-based security responses
Applications can move from server to server in the grid, so no server can be identified as a location for a specific application-targeted attack
Inter-process communication is learned by Microservices and not pre-programmed in—this allows adaptation and evolution of not just keys, but communication protocols.
Grid agent technology allows event-driven swarming of counter-intrusion agents throughout the network grid.
The service grid is self-managing and self-healing—when problems occur, it automatically assembles the correct reaction team with full data and tools to respond

### Inter-Enterprise Collaboration: Network Effect

Ellipsis allows a unique benefit when it is deployed across cooperating partners in a supply chain. When partners deploy Ellipsis they are able to share sophisticated policy data regarding inventory that is simply impossible with any other system. Refined knowledge and policy gained at one location can be passed along to other supply-chain participants. This creates a powerful incentive to recommend the system to trading partners.

Basically, the RFID Agent collects and stores detailed data as it moves along. Partners downstream in the supply chain can utilize the additional data provided by earlier transit points. If an Return Merchandise Authorization (RMA) is ever invoked, or the item need repair, originating supply chain members can gain access to vital history of transit and use data from the RFID agent.

But the RFID Agent can also store policy. This behavioral and reaction information also provides value as it moves downstream in the supply chain. Manufactures can add information about how to treat the item under environmental changes. The RFID Agent is extensible and new policy and state information can be added in downstream supply chain participants. Distribution partners can add policy, that might for example, send an automatic tracking event, triggered when the item departs a regional warehouse, so that upstream suppliers can know to replenish the item.

But this potential value must be tempered with proper security considerations so that all supply chain participants can gain the benefit they desire without compromising integrity. The normal value chain using Ellipsis must be understood to be a ‘trusted’ system where everyone plays by known accepted rules. RFID-agents entering a users Ellipsis community must be allowed to depart with all the information they have gained. That is, a user generally should not restrict information about where the item was warehoused and any environmental conditions that might have been recorded for that location. This is called an Ellipsis Full Trust environment. Strong advantages exist when standard Service Grid service/container security is allowed to govern transit of services across organization boundaries. Far from frictionless, such a normal transit would still involve secure validation of the foreign derived service before the container will allow it to load and execute. In addition the local container will enforce an accounting transaction to be logged that provides a record that the service deployed in this specific container for this specific time.

Claimed in all instances:

The method
the computer system
the software
Byte code/media
Java exemplary implementation
.NET exemplary implementation
other technology implementations
the apparatus

1. Claim method of Microservices in a distributed computer grid for provision of distributed computing. Such Microservice to consist of
a small, re-locatable agent-service that may act as a resource for other services
a modification of the mobile agent software template with the removal of any internal itinerary: in effect, the removal of self generated mobility and the replacement of this with 3^{rd} party authentication and deployment control thru a management agent
the inclusion of advertisement and discovery functions to find other Microservices
simple enough business functionality to support Rapid Application Development
support for one functional business interface and required administrative interfaces
such internals as to include XRI naming, Code facilitating deployment into a container, Smart reconnect proxy for remote service communication, service interface, security interface, accounting interface, management interface, expression of internal data as XML, Standard management information (via API and XML), Extensible management information as XML.

2. Further claim the item in 1 above, wherein Policy Agents are created by including data and ECA statements in a Microservice.

3. Further claim the item in 2 above augmented with the provision of virtual intelligence including history and policy for RFID tagged items including one or more of:
data including one or more of type of item, family classification of item and uses, serial number, manufacturing lot numbers, creation place and date, composition, assignment or ownership;
contains event, condition, action (ECA) statements that embody policy for the item including but not limited to one or more: liability polices, environmental policies, handling instructions, RMA treatment, disposal instructions;
contain links to service level agreements that cover the item;
facility to add information as the item moves through its life cycle, including one or more of: location-time history, environmental factors history, damages and repairs, ownership or responsible body transfers.

4. Further claim the item in 3 above with use of mobility with policy agents and services for providing utility for RFID life-cycle management by:
allowing software agents to ‘follow’ an item through the supply chain;
link with a local system to provide data capture;
provide business process automation;
provide security.

5. Further claim item in 4 above to replace of Auto-Id protocols and other value chain protocols with mobile services.

6. Further claim item 2 above providing mobile, distributed intelligence for RFID and other value-chain physical components including: Id-agent, RFID-agent, RFID-Super-agent.

7. Claim the method of a Service Grid by the deployment of Microservices on a generalized network of computers (Compute Grid) and network of data repositories (Data Grid).

8. Further claim item in 7 above where the use of policy agents in a grid provides for Adaptive computing.

9. Further claim the item in 1 above as a representation of a Component (both business and framework component types) with a contract/interface service fronting a community of interacting Microservices.

10. Claim the method of use a service grid for providing utility for RFID life-cycle management including use as RFID middleware, data collection, data processing and business processes implementation & control.

11. Further claim the item in 10 with forward deployment (that is into close proximity with location of business processes) of software services to provide business process automation near RFID readers and tagged items.

12. Further claim the item in 11 used to create a system (named Ellipsis) being a group of components including: RFID agents, local policy agents, HIJAS-MS and HIJAS.

13. Further claim in 11 the specific functions, services, components, and other component parts for HIJAS Manager Subsystem (HIJAS-MS) including:
The use to deploy and manage one or more individual HIJAS throughout its life-cycle, by launching participating services as identified by a template in the Registry and launched by a dedicated Life-cycle Manager;
When, on demand, a specific bit of logic or task is needed; a software factory manufactures the micro service instance that then launches to a local HIJAS and connects to the Javaspace therein
Providing all of some of the functions for: remote launching HIJAS, remote launching Javaspaces or other tuple-space, proxy registration of services, group integrity and survivability, remote Notification interfaces (JMS), cloning and synchronization of javaspace and other services, state and data replication services;
Utility services including: Agent Factories & Group Watcher.

14. Further claim the item in 11 used to create a system (named HIJAS) being all components, and component parts for HIJAS, that is, the functions, services and mix of agent types including a Javaspace and zero, one or more of: Adapter, Aggregator, Policy Agent, Translator Agent for non EID tags, Remote Notification Agent, Entry Replication Agent, Entry Find and Fetch Agent, Persistence Agents (by Business Object class), Logging Agent, Automation/Reaction agent, Ego-agent, Super-ego proxy connectors, Grouping proxy connectors, Auto-id mimic services.

15. Further claim the item in 14 for providing the specific deployed functionality of RFID life-cycle management subsystem including use as RFID middleware, data collection, data processing and business processes implementation & control.

16. Further claim the item in 14 for use as a Gateway component & aggregate component interface to the grid, fronting for the foreign (non service grid) heritage (different architecture) application while providing integration with foreign, heritage applications.
